(19) United States
(12) Patent Application Publication
(10) Pub. No.: US 2013/0217039 A1
(43) Pub. Date: Aug. 22, 2013

(54) OPTICAL PATHOGEN DETECTION SYSTEM AND QUALITY CONTROL MATERIALS FOR USE IN SAME

(71) Applicants: R. Steven Brown, Kingston (CA); Eric Marcotte, Kingston (CA); Michael Miron, Kingston (CA); Tom Radcliffe, Kingston (CA)

(72) Inventors: R. Steven Brown, Kingston (CA); Eric Marcotte, Kingston (CA); Michael Miron, Kingston (CA); Tom Radcliffe, Kingston (CA)

(73) Assignees: QUEEN'S UNIVERSITY AT KINGSTON, Kingston, ON (CA); PATHOGEN DETECTION SYSTEMS, INC., Kingston, ON (CA)

(21) Appl. No.: 13/704,708

(22) PCT Filed: Jun. 20, 2011
(86) PCT No.: PCT/CA11/00717

§ 371 Date: May 3, 2013

Related U.S. Application Data
(60) Provisional application No. 61/356,364, filed on Jun. 18, 2010.
(60) Provisional application No. 61/356,384, filed on Jun. 18, 2010.
(60) Provisional application No. 61/356,445, filed on Jun. 18, 2010.

(51) Int. Cl. G01N 21/64

(52) U.S. Cl. CPC G01N 21/6486
USPC 435/7.72; 252/301.35; 252/582; 435/287.2; 435/7.9; 435/288.7

(57) ABSTRACT

A system for detecting presence of an organism having an enzyme in a sample, comprising: a cartridge for containing the sample and a substrate such that the enzyme can react with the substrate to produce a biological molecule; a partitioning element mounted in a recess in a base of the cartridge, the partitioning element allowing partitioning of the biological molecule thereinto; a light source for irradiating the biological molecule partitioned into the partitioning element; and, a detector for detecting fluorescence of the biological molecule partitioned into the partitioning element, the detected fluorescence being indicative of presence of the organism in the sample; wherein the light source is in a raised cartridge mount of the system that mates with the recess in the base of the cartridge. Also provided is a method for calibrating said system and quality control cartridges for use in same.

This application claims priority from U.S. Provisional Patent Application Nos. 61/356,445; 61/356,384, and 61/356,364 all filed Jun. 18, 2010, and incorporated herein by reference.

### FIELD OF THE INVENTION

This invention relates to the field of detection methods and systems, and more specifically, to a method and system for detecting biological molecules in samples. In one embodiment, this invention relates to an optical pathogen detection system and to quality control materials for use in optical pathogen detection systems. In one aspect this invention relates to fluorophore mimics of molecules associated with the absence or presence of certain pathogens in an optical detection system. In another aspect, the invention relates to a method of calibrating an optical pathogen detection system.

### BACKGROUND

The ability to detect biological molecules associated with enzyme activity has application in fields such as testing for biological contamination of water and food products. Of particular interest is the ability to detect biological (e.g., bacterial) contamination of water. Several known methods for detection of bacteria such as Escherichia coli (E. coli or “EC”) and total coliform (“TC”) are based on detection of indicator enzyme activity in a broth designed to promote growth of the target organism. Accepted indicator enzymes are β-glucuronidase (β-glu) and β-galactosidase (β-gal) for EC and TC, respectively. Methods which use these enzymes rely on a reaction of the enzyme with a chromogenic or fluorogenic compound to measure the enzyme activity. In the case of β-glu or β-gal, usually a glucuronide or galactoside conjugate of a dye compound is added to the sample broth as a substrate, and if the target enzymes are present, the conjugate is converted to a free dye molecule. The enzyme-dependent conversion is detected by a change in colour or fluorescence of the free dye molecule compared to the conjugate. Some methods use soluble products detected in solution, with the coliform cells usually also suspended in solution. Others methods use coliform cells on the surface of a filter, membrane, or gel, usually with an insoluble dye product which adsorbs onto the support to form a coloured or fluorescent spot around colonies of target organisms. Some supported formats use multiple dye substrates which produce a variety of colours depending on which organisms are present.

However, the above methods are vulnerable to sources of error, such as suitability of broth and incubation conditions for all target coliform types, as well as presence of non-target organisms which may contribute to the indicator enzyme activity. Nonetheless, the reliability of established methods is high enough that there is broad regulatory acceptance of these methods for assessment of samples ranging from meat products to drinking water.

Further, in routine or commercial uses of such substrates, detection is usually done visually by the human eye, which presents significant limitations in performance. A large number of coliform cells must be present before enough substrate will be converted for the product to be visible. This requires significant incubation and growth for detection of a small initial number of cells, and a standard 100 mL sample is incubated for 24 hours to provide a detection limit of one coliform cell in the initial sample. In some cases, more rapid detection is possible, but normally only with a higher detection limited accepted (e.g., 100 to 300 cells in a 100 mL sample). Also, visual detection is not quantitative, and these tests are normally used in a “presence/absence” mode where the actual number of coliform cells is not determined unless a more complex “most-probable number” method is used. Exceptions to the latter are some plating methods, where the number of colonies is counted and therefore the number of cells in the sample quantitatively determined. This, however, is a very labour-intensive, time-consuming process which also requires long incubation, and has limited dynamic range.

U.S. Pat. No. 7,402,426 to Brown et al., the entirety of which is herein incorporated by reference, provides a solution to several of the above shortcomings.

In U.S. Pat. No. 7,402,426, a method for detecting a biological molecule associated with activity of at least one enzyme in a sample is described, the method comprising:
combining at least one enzyme with at least one substrate under conditions which allow for the enzyme to react with the substrate;
providing a partitioning element for partitioning of said biological molecule thereinto; and
detecting fluorescence of said biological molecule in said partitioning element;
wherein said detected fluorescence is indicative of activity of said enzyme in the sample.

In one embodiment, the biological molecule partitions into the partitioning element and the at least one substrate does not partition into the partitioning element.

In one aspect, said at least one substrate is selected from pyrene-.beta.-D-glucuronide, anthracene-.beta.-D-glucuronide, pyrromethene-.beta.-D-glucuronide, pyrene-.beta.-D-galactopyranoside, and anthracene-.beta.-D-galactopyranoside.

In one embodiment, the enzyme is beta.-glucuronidase and .beta.-galactosidase and is associated with the presence of pathogens, such as E. coli and total coliform, respectively.

In particular the use of said method in determining the presence of pathogens, such as E. coli and total coliform, in a sample (e.g. water, biological sample, food, or soil) is described.

In one embodiment, the partitioning element is a polymer film, such as poly hydrophobic polymer, such as polydimethylsiloxane (PDMS).

In another embodiment, U.S. Pat. No. 7,402,426 describes a system for detecting a biological molecule in a sample associated with the presence of an organism having at least one enzyme in a sample is described. The system comprises: a vessel for incubating the sample and at least one substrate such that the at least one enzyme can react with the at least one substrate to produce a biological molecule; a solid partitioning element that allows partitioning of only one of said biological molecule and said at least one substrate thereinto, the partitioning element not including an indicator agent that interacts with said biological molecule or said at least one substrate; an excitation light source that irradiates said biological molecule or said at least one substrate partitioned into said partitioning element; a detector that detects fluorescence of said biological molecule or said at least one substrate partitioned into said partitioning element; and a control unit; wherein said detected fluorescence is indicative of presence of said organism in the sample. The system can further comprise a communications unit that relays data relating to fluorescence detection to a communications network.

In one embodiment of the invention, the control unit performs at least one function selected from controlling operation of said system, storing data relating to fluorescence detection, and outputting data relating to fluorescence detection.

In one embodiment, U.S. Pat. No. 7,402,426 describes a system of wherein the vessel comprises a removable cartridge for containing the sample and the substrate. In one embodiment, the partitioning element is disposed in said removable cartridge.

In U.S. Pat. No. 7,402,426, a means for calibrating said partitioning element and/or optical components of the system or for monitoring said fluorescence detection, or both, is also described.

In one embodiment, the means for calibrating said partitioning element and/or optical components and/or for monitoring said fluorescence detection comprises: a fluorophore that partitions into said partitioning element and fluoresces at a different wavelength than said biological molecule; wherein said fluorescence of said fluorophore is detected by the detector; and wherein said control unit uses the detected fluorescence to calibrate the partitioning element and/or optical components of the system or to monitor fluorescence detection of the system.

Calibration and quality control methods typically use samples that are known to have certain substances in them (such as in the case of a positive control, known amount of enzyme producing bacteria or the enzyme) that should provide known results against which other samples are compared. For instance, if the system upon calibration detects a positive signal for a sample that has known amounts of bacteria/enzyme, the signal can be associated with that level of activity. Similarly the system can be calibrated for samples that are known to have no bacteria/enzyme. Negative controls can be used for example to determine background signals. The detection system can then be calibrated accordingly. Signals from samples where activity or presence of a substance is not known can be compared with signals from the controls to determine their level of activity. However, many of the calibration methods require a lab to have a supply of known pathogen. Further, the reacted fluorophores used in the prior art have a short half-life, often hours, they cannot be stored for long periods of time, as such it is time consuming to prepare them, especially as they, as well as the test sample need to be incubated and undergo the enzyme substrate reaction prior to use. In addition they are all aqueous controls so are more difficult to transport and use and are susceptible to contamination that can alter the calibration and thus the testing results.

Although various calibration methods have been previously described, a need exists to improve the efficiency of systems such as in U.S. Pat. No. 7,402,426, and for quality control material and methods that can be used to calibrate the system, that can be reusable, stored for extended periods of time (e.g. days, weeks or months) and which provide consistent signal.

### SUMMARY OF THE INVENTION

According to one aspect of the invention there is provided a method for detecting a biological molecule associated with activity of at least one enzyme in a test sample, comprising: combining at least one enzyme with at least one substrate under conditions which allow for the enzyme to react with the substrate; providing a partitioning element for partitioning of said biological molecule thereinto; and detecting fluorescence of said biological molecule in said partitioning element; wherein the intensity of said fluorescence is compared to a control sample to determine the presence or absence or level of activity of said enzyme.

When the intensity of said fluorescence in said test sample is greater than that of a negative control, this is indicative of the presence of activity of said enzyme within said test sample. The fluorescence intensity of said test sample or the time it takes for a test sample to reach a particular fluorescence intensity can be used as being indicative of the level of enzyme activity in said test sample.

When the intensity of said fluorescence in said test sample is compared to a positive control, the presence or absence of enzyme activity or level of such activity depending on time it takes for test sample to reach a particular intensity can be determined with respect to the activity of said positive control.

In one aspect of the invention a calibration curve can be established using both negative and positive controls which will emit fluorescence activity that mimic known levels of enzyme activity. The intensity of fluorescence activity can then be compared to said calibration curve to determine level of enzyme activity in said test sample and/or calibrate optical signal at the desired wavelength of the pathogen detection system. In another embodiment, the controls are established to provide a particular level of intensity at the spectra that is indicative of enzyme activity in a test sample. Thus in one embodiment the controls are used to calibrate optical readings and calibrate the optical function the optical system at that particular spectra reading. The controls can also be used to determine when the optical system requires cleaning or maintenance or the like. Again as the controls are designed to provide a known signal intensity at a particular wavelength, use of the controls can determine the functioning of the optical system at that wavelength or spectra.

In one embodiment, said partitioning element comprises a polymer film, such as polydimethylsiloxane (PDMS). In one embodiment, said conditions which allow for the enzyme to react with the substrate in a test cartridge comprise aqueous conditions.

In one embodiment, the biological molecule is the substrate and said detecting fluorescence comprises detecting a change in amount of fluorescence. In another embodiment, the biological molecule is a product of the enzyme-substrate reaction.

In one embodiment, the enzyme activity is associated with a microorganism and the method is used for detecting a biological contaminant in a sample wherein said fluorescence is indicative of said biological contaminant in the sample.

In one embodiment, the microorganism is a biological contaminant. In another embodiment the at least one enzyme is selected from β-glucuronidase and β-galactosidase. In another embodiment, the microorganism is selected from E. coli and total coliform. In various embodiments the at least one substrate is selected from pyrene-β-D-glucuronide, anthracene-β-D-glucuronide, pyrromethene-β-D-glucuronide, pyrene-β-D-galactopyranoside, and anthracene-β-D-galactopyranoside, and the enzyme activity is detected in a sample selected from water, a biological sample, food, and soil.

In one embodiment, said enzyme and substrate are combined in a cartridge comprising said partitioning element.

In various embodiments the sample is selected from water, a biological sample, food, and soil. In one embodiment said fluorescence of a product of the enzyme-substrate reaction is detected by partitioning of the product into the partitioning element and detected by an optical probe.

In one embodiment said conditions which allow for the enzyme to react with the substrate comprise aqueous conditions. In another embodiment said enzyme is at least one of β-glucuronidase and β-galactosidase. In a further embodiment said microorganism is selected from E. coli and total coliform. In further embodiments, said at least one substrate is selected from pyrene-β-D-glucuronide, anthracene-β-D-glucuronide, pyrromethene-β-D-glucuronide, and pyrene-β-D-galactopyranoside.

According to one aspect of the invention, there is provided a system for detecting the presence of an organism having an enzyme in a sample, comprising: a test cartridge for containing the sample and a substrate such that the enzyme can react with the substrate to produce a biological molecule; a partitioning element, in one embodiment the partitioning element is in the cartridge, in another embodiment the partitioning element is mounted in a recess in a base of the cartridge, the partitioning element allowing partitioning of the biological molecule thereinto; a light source for irradiating the biological molecule partitioned into the partitioning element; and, a detector for detecting fluorescence of the biological molecule partitioned into the partitioning element, the detected fluorescence being indicative of presence of the organism in the sample; wherein the light source is in a raised cartridge mount of the system that mates with the recess in the base of the cartridge.

In one embodiment the invention provides a method for calibrating the system by comparing the intensity of the fluorescence detected in a test cartridge to that of one or more quality control cartridges, comprising using a polymer, which may be a polymer film, such as PMDS, or in one embodiment the same polymer film as used in the partitioning element of the test cartridge, with a fluorophore incorporated therein that mimics, wherein upon irradiation by the light source, a positive reading for TC or EC+TC or a negative reading for same is obtained. In one embodiment with regard to the positive controls, the intensity of the fluorescence will mimic a particular amount of enzyme activity. In one embodiment the enzyme activity is associated with the absence or presence of a microorganism or pathogen. As such, in one embodiment, the invention provides a control material comprising said polymer film and fluorophore that upon irradiation provides a consistent predetermined fluorescence intensity at the desire spectra or wavelength. In one embodiment a control unit uses the fluorescence of the control material detected by the detector to calibrate the partitioning element and/or optical components of the system or to monitor fluorescence detection of the system.

In one aspect the control material is placed in a quality control cartridge and positioned similarly in the cartridge as would be the partitioning element in the test cartridge. In one embodiment the control material is in the base of the quality control cartridge.

In one embodiment, the fluorophore is selected for stability of fluoroscence reading and intensity over time and its ability to mimic readings of positive and/or negative enzyme activity of control test samples, as the case maybe.

In one embodiment, for the purpose of mimicking signals from hydroxypyrene (with regard to detecting presence of enzyme activity associated with E. coli), which is monitored at 385 nm, and from hydroxyanthracene (with regard to detecting presence of enzyme activity associated with total coliform (TC)) which is monitored at 485 nm, the fluorophores in the control material or quality control cartridge are chosen such that one would produce a signal at 385 nm but not at 485 nm, and the other would produce a signal at 485 nm but not at 385 nm. Other than achieving this requirement, it is not necessary for the fluorophores in the quality control cartridge to exactly reproduce the entire spectrum of hydroxypyrene and hydroxyanthracene.

In one embodiment, the fluorophore to produce the 385 nm signal is Exalite 398. In one embodiment, the fluorophore to produce the 485 nm signal is Coumarin 540a.

In another embodiment, 0.1 Coumarin 540a/g polymer is used for the positive TC control. In another embodiment this control also comprises DCM to reduce background signal, for instance 0.05 mg DCM/g polymer.

In one embodiment, a cartridge mimicking the sample of E. coli and TC contains 0.075 mg Coumarin 540a/g polymer and 0.075 mg Exalite 398/g polymer. In addition, in another embodiment the cartridge may comprise DCM polymer, for instance 0.05 mg DCM/g polymer.

In yet another embodiment, the invention provides a negative control, preferably a negative quality control cartridge comprising polymer and DCM, such as 0.05 mg DCM/g polymer.

In one embodiment the quality control cartridge is a non-aqueous system which comprises the polymer and fluorophore incorporated therein in the base of a cartridge.

In another embodiment, the quality control cartridge is reusable. In another embodiment, the quality control cartridge may be used over days, in another embodiment over weeks, in yet another embodiment over months, in another embodiment for up to one year, in yet another embodiment for more than one year or years.

In yet another embodiment, the quality control cartridge provides consistent signal intensity over time and can be used to calibrate and determine or monitor optical reading efficiency of the system or functioning of the system of the present invention, and in one embodiment over time.

In yet another embodiment the invention provides a kit for said pathogen detection system and method of calibration thereof comprising one or more said control materials and/or quality control cartridges. In one embodiment said kit comprises negative controls, positive controls, or both. In another embodiment the kit comprises test cartridges comprising a partitioning element and a substrate for enzyme activity to be detected. In another embodiment, the kit comprises all or part of the apparatus or optical detection system as described herein. In one embodiment, the kit comprises instructions for use of said kit components and/or methods of conducting the pathogen detection using the kit and system of the present invention.

In one embodiment, the invention provides a method of calibrating a system of the invention by first placing a quality control cartridge in a test chamber to calibrate the readings from the test chamber prior to placing a test cartridge therein. The test chamber may be calibrated using negative controls, positive controls, (e.g. quality control cartridges) or both. In one embodiment the controls are for use in the method of the present invention or in calibrating the system of the present invention. This may be done for each test chamber of the system. Alternatively, it may be done with one or more test chambers of the system. In one embodiment, calibration curves may be established for the presence or absence of enzyme activity using both negative and positive quality control cartridges or positive quality control cartridges which mimic different levels of enzyme activity at a particular wavelength or spectra and thus associated microorganism presence. In another embodiment calibration curves are established against which the fluorescence intensity of the test sample is compared to determine enzyme activity and in one embodiment the presence of a microorganism in a test sample.

In accordance with further aspects of the present invention there is provided a method, an apparatus such as a test system, a method for adapting this system, as well as articles of manufacture such as a computer readable medium (or product) having program instructions recorded thereon for practising the method of the invention.

### BRIEF DESCRIPTION OF THE DRAWINGS

Features and advantages of the embodiments of the present invention will become apparent from the following detailed description, taken in combination with the appended drawings, in which:

FIG. 1 is a front perspective view illustrating a test system with its lid in a closed position and a test cartridge in accordance with an embodiment of the invention;

FIG. 2 is a front perspective view illustrating the test system of FIG. 1 with its lid in an opened position in accordance with an embodiment of the invention;

FIG. 3 is a front view illustrating the test system of FIG. 1 with its mantel in an opened position in accordance with an embodiment of the invention;

FIG. 4 is an expanded perspective view illustrating the test system of FIG. 1 in accordance with an embodiment of the invention;

FIG. 5 is a front perspective view illustrating the mantel of the test system of FIG. 1 in accordance with an embodiment of the invention;

FIG. 6 is a front perspective view illustrating incubators within the mantel of FIG. 5 in accordance with an embodiment of the invention;

FIG. 7 is a front perspective view illustrating the upper surface of an optical board of the test system of FIG. 1 in accordance with an embodiment of the invention;

FIG. 8 is a front perspective view illustrating the lower surface of the optical board of FIG. 7 in accordance with an embodiment of the invention;

FIG. 9 is a top view illustrating a portion of the upper surface of the optical board of FIG. 7 in accordance with an embodiment of the invention;

FIG. 10 is a cross sectional view illustrating a raised cartridge mount of the optical board of FIG. 7 in accordance with an embodiment of the invention;

FIG. 11 is a partial cross sectional view illustrating a test cartridge installed on a raised cartridge mount in the test system of FIG. 1 in accordance with an embodiment of the invention;

FIG. 12 is a front perspective view illustrating a test cartridge with its lid in a held closed position in accordance with an embodiment of the invention;

FIG. 13 is a front perspective view illustrating the test cartridge of FIG. 12 with its lid in an opened position in accordance with an embodiment of the invention;

FIG. 14 is a front perspective view illustrating the test cartridge of FIG. 12 with its lid in a locked closed position in accordance with an embodiment of the invention;

FIG. 15 is a cross sectional view illustrating the test cartridge of FIG. 12 with a partitioning element installed in accordance with an embodiment of the invention;

FIG. 16 is a cross sectional detail view illustrating the test cartridge of FIG. 12 with a partitioning element installed in accordance with an embodiment of the invention;

FIG. 17 is a front perspective view of a partitioning element in accordance with an embodiment of the invention;

FIG. 18 is a front view of the partitioning element of FIG. 17 in accordance with an embodiment of the invention;

FIG. 19 is a block diagram illustrating an optical system of the test system in accordance with an embodiment of the invention;

FIG. 20 is a block diagram illustrating a data processing system of the test system in accordance with an embodiment of the invention;

FIG. 21 is a screen capture illustrating a input screen of a graphical user interface (“GUI”) of the test system in accordance with an embodiment of the invention;

FIG. 22 is a screen capture illustrating a second input screen of a GUI of the test system in accordance with an embodiment of the invention;

FIGS. 23 and 24 are screen captures illustrating test status screens of a GUI of the test system in accordance with an embodiment of the invention;

FIGS. 25 and 26 are screen captures illustrating positive test result screens of a GUI of the test system in accordance with an embodiment of the invention;

FIGS. 27 and 28 are screen captures illustrating negative test result screens of a GUI of the test system in accordance with an embodiment of the invention;

FIG. 29 is a screen capture illustrating an alternate test result screen of a GUI of the test system in accordance with an embodiment of the invention.

FIGS. 30-32 are perspective, front, and cross sectional views, respectively, illustrating an alternate partitioning element in accordance with an embodiment of the invention;

FIGS. 33-35 are perspective, front, and cross sectional views, respectively, illustrating an alternate partitioning element in accordance with an embodiment of the invention;

FIGS. 36-40 are perspective, bottom, front, rear, and side views, respectively, illustrating fiber optic bundling in accordance with an embodiment of the invention;

FIG. 41 is a graph illustrating the spectra of quality control cartridges in accordance with an embodiment of the present invention; and

FIG. 42 is a graph illustrating the spectra of a blank and a quality control negative cartridge in accordance with an embodiment of the present invention.

It will be noted that throughout the appended drawings, like features are identified by like reference numerals.

### DETAILED DESCRIPTION OF THE EMBODIMENTS

In the following description, details are set forth to provide an understanding of the invention. In some instances, certain software, circuits, structures and methods have not been described or shown in detail in order not to obscure the invention. The term “biological molecule” is used herein to refer to any molecule which can function as a substrate of an enzymatic reaction, or any molecule that can be produced by an enzymatic reaction, regardless of whether the molecule is found in nature. The term “data processing system” is used herein to refer to any machine for processing data, including the computer systems and network arrangements described herein. Aspects of the present invention may be implemented in any computer programming language provided that the operating system of the data processing system provides the facilities that may support the requirements of the present invention. Any limitations presented would be a result of a particular type of operating system or computer programming language and would not be a limitation of the present invention. Aspects of the present invention may also be implemented in hardware or in a combination of hardware and software.

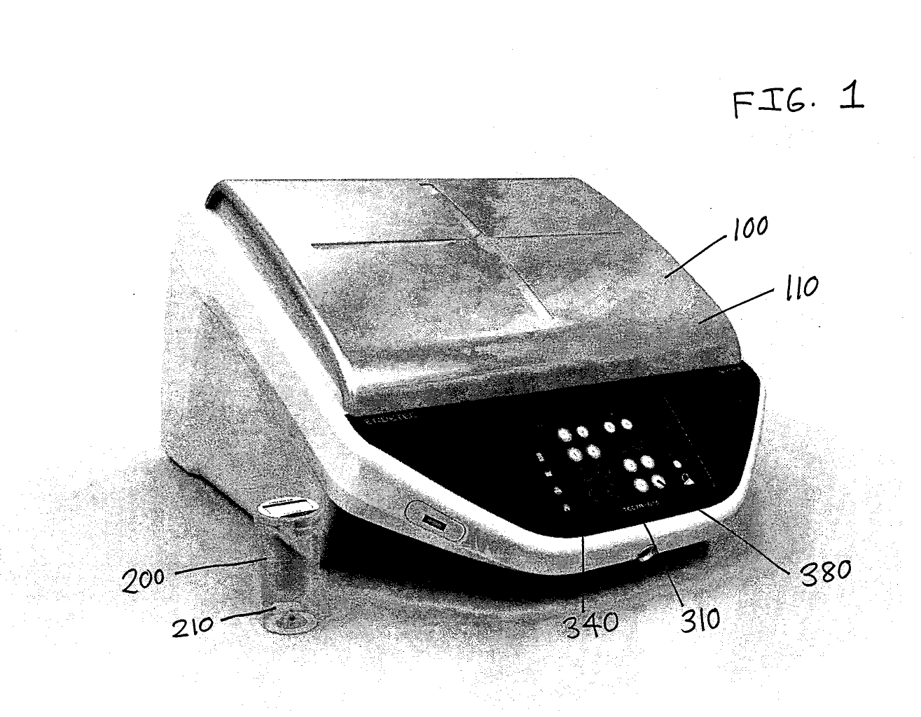

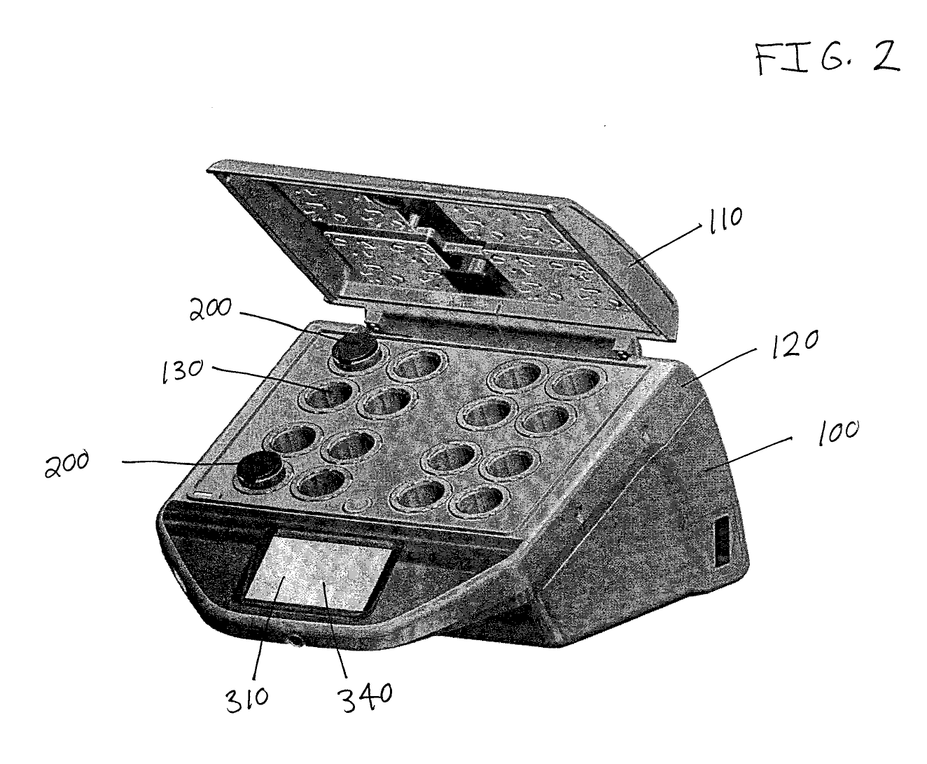

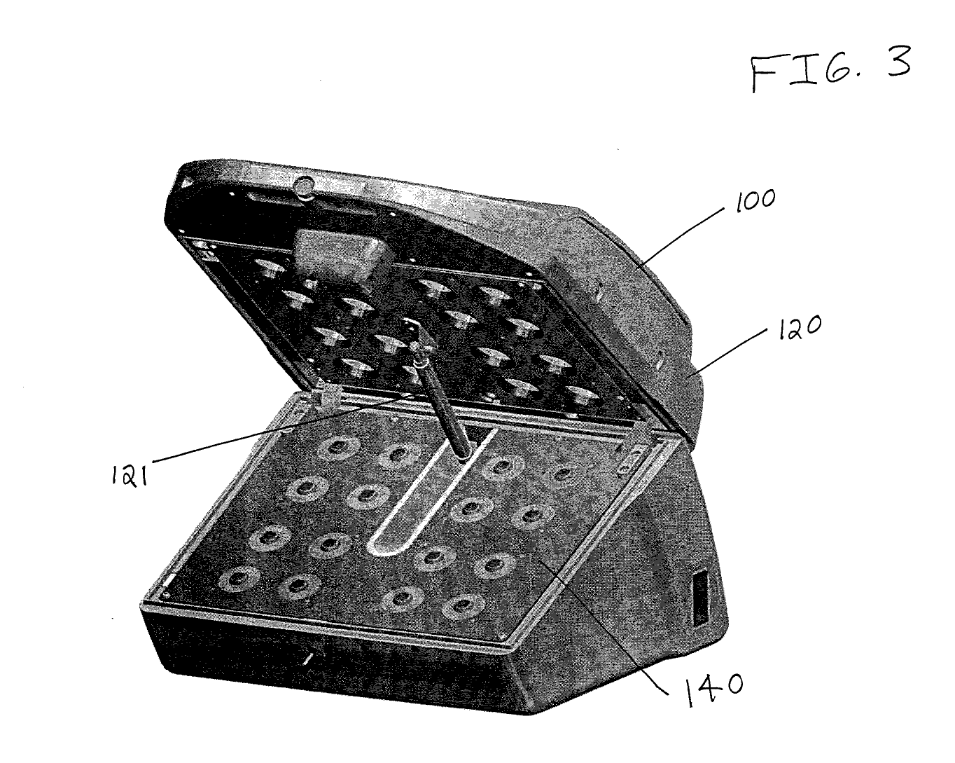

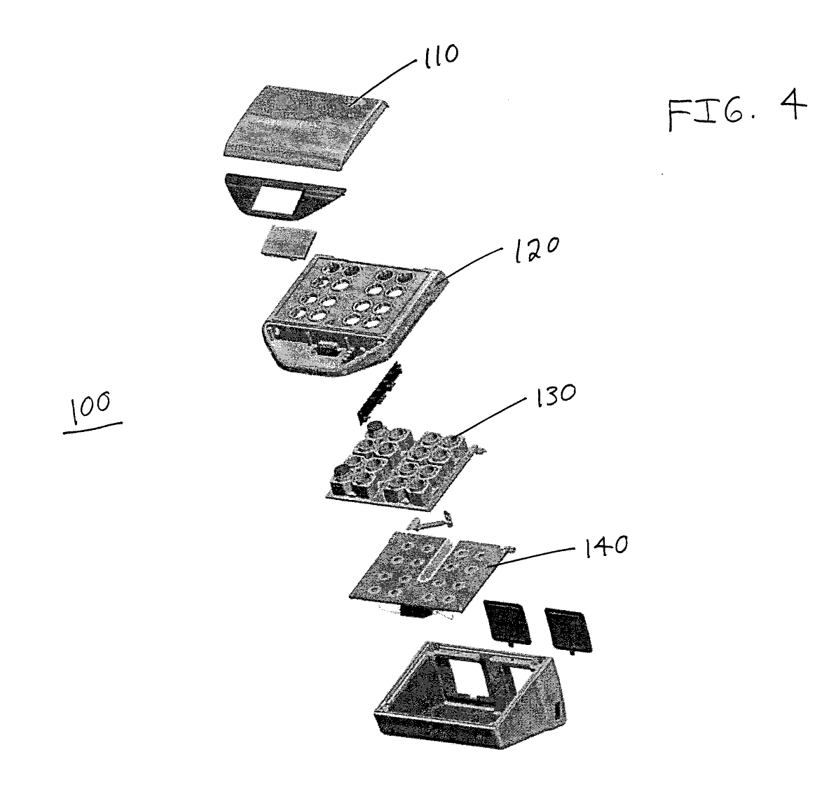

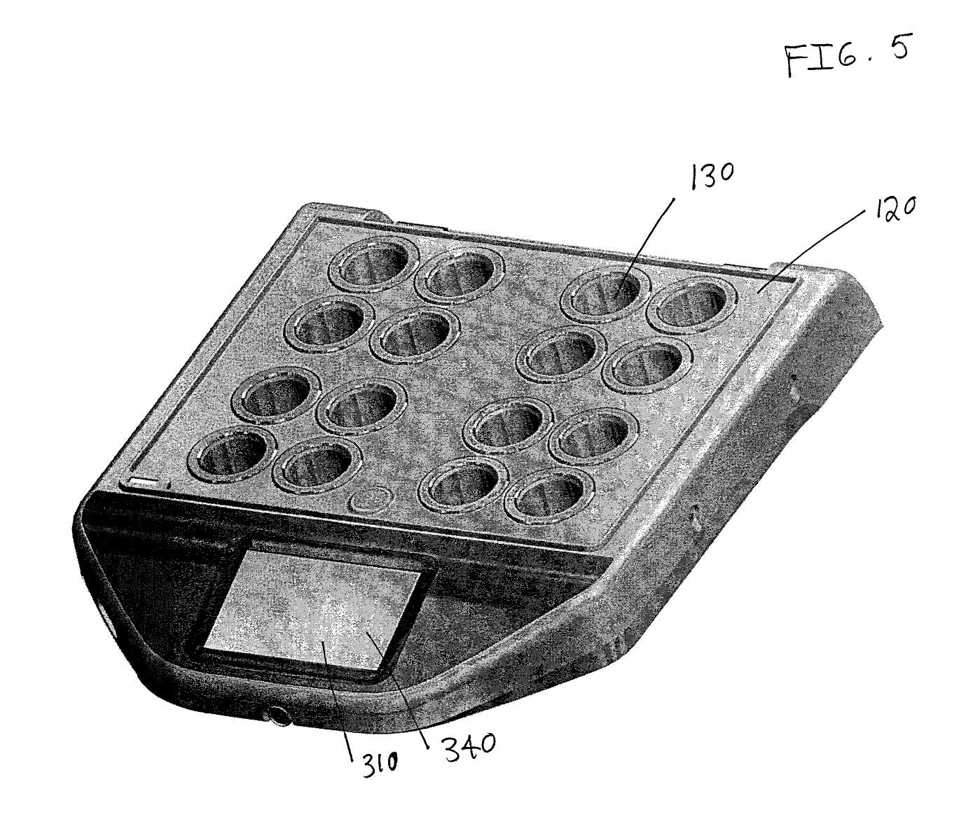

FIG. 1 is a front perspective view illustrating a test system 100 with its lid 110 in a closed position and a test cartridge 200 in accordance with an embodiment of the invention. FIG. 2 is a front perspective view illustrating the test system 100 of FIG. 1 with its lid 110 in an opened position in accordance with an embodiment of the invention. FIG. 3 is a front view illustrating the test system 100 of FIG. 1 with its mantel 120 in an opened position in accordance with an embodiment of the invention. FIG. 4 is an expanded perspective view illustrating the test system 100 of FIG. 1 in accordance with an embodiment of the invention. FIG. 5 is a front perspective view illustrating the mantel 120 of the test system 100 of FIG. 1 in accordance with an embodiment of the invention. And, FIG. 6 is a front perspective view illustrating incubators 130 within the mantel 120 of FIG. 5 in accordance with an embodiment of the invention.

According to one embodiment, a sample to be tested is placed in a test cartridge 200 which contains a substrate 210. The test cartridge 200 is then placed in an incubator or test chamber 130 in the mantel 120 of the test system 100. The lid 110 of the test system 100 may then be closed to begin a test for biological molecules associated with enzyme activity within the sample as will be described below. The incubator 130 may have a heating system associated therewith for heating the sample in the test cartridge 200. The mantel 120 may be hinge mounted within the test system 100 and may be opened to access an optical board 140 for cleaning and maintenance. A piston 121 may be used to keep the mantel 120 in an opened position. The test system 100 may be modular in design, as shown in FIG. 4, to facilitate cleaning, replacement, and maintenance of various modules or components (e.g., 120, 130, 140) of the test system 100.

According to one embodiment, cartridges 200 are held at an angle (e.g., 25 degrees) in the incubators 130 to minimize residue build-up on the optical elements and board 140 while avoiding contact of sample liquid with the lid of the cartridge 200. This may be accomplished by mounting the mantel 120 and optical board 140 at an angle within the test system 100.

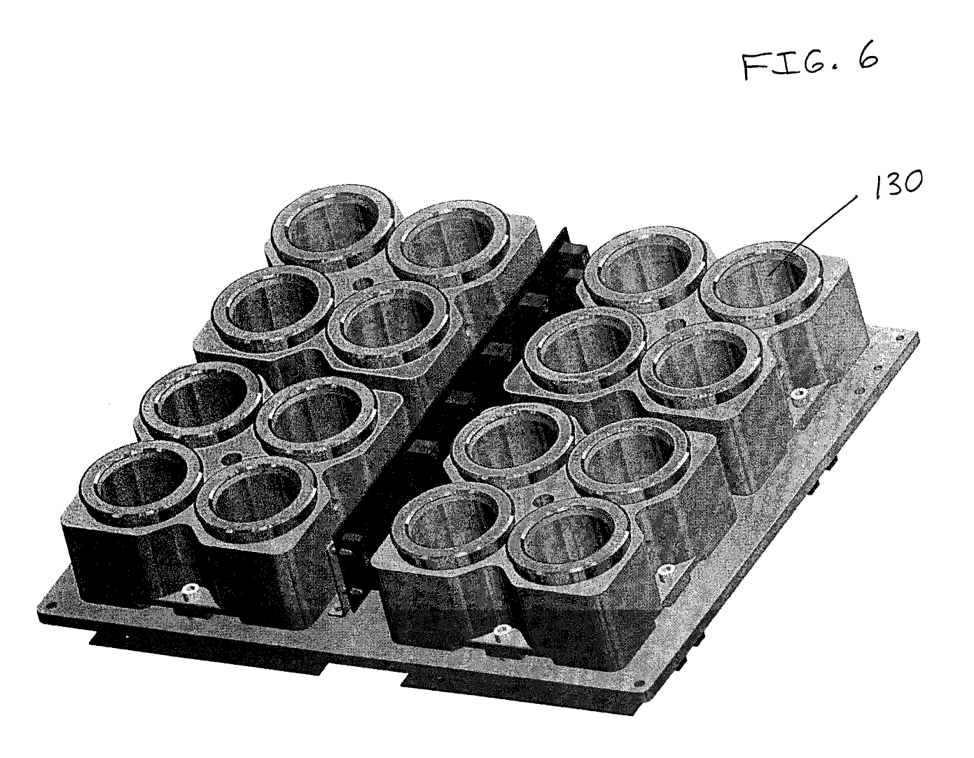

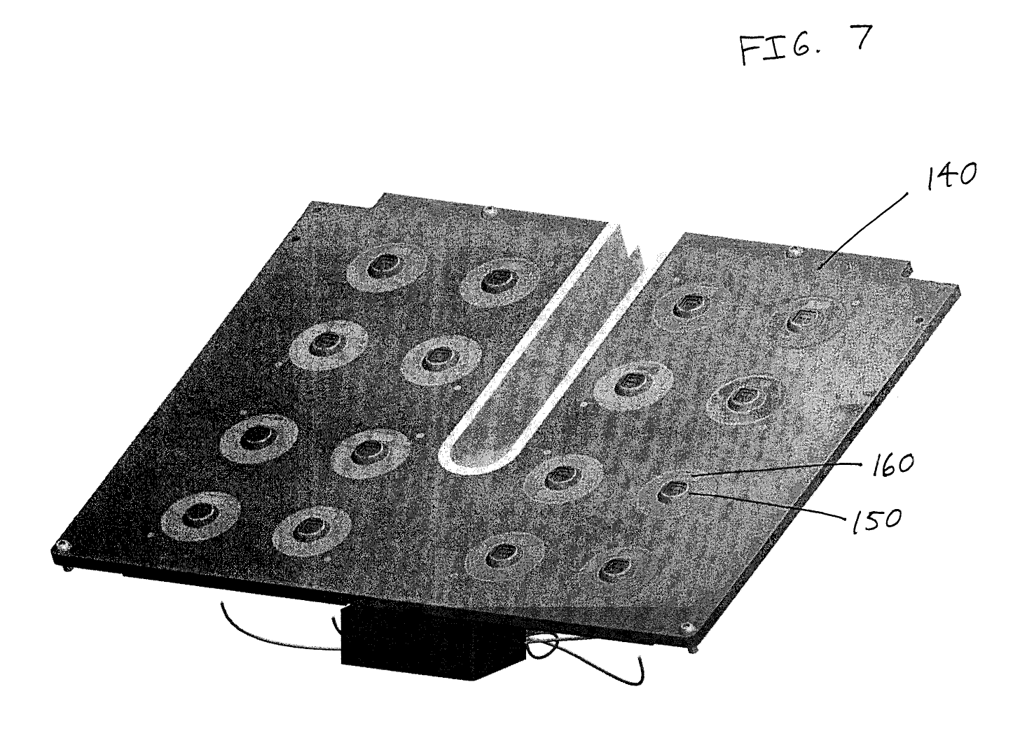

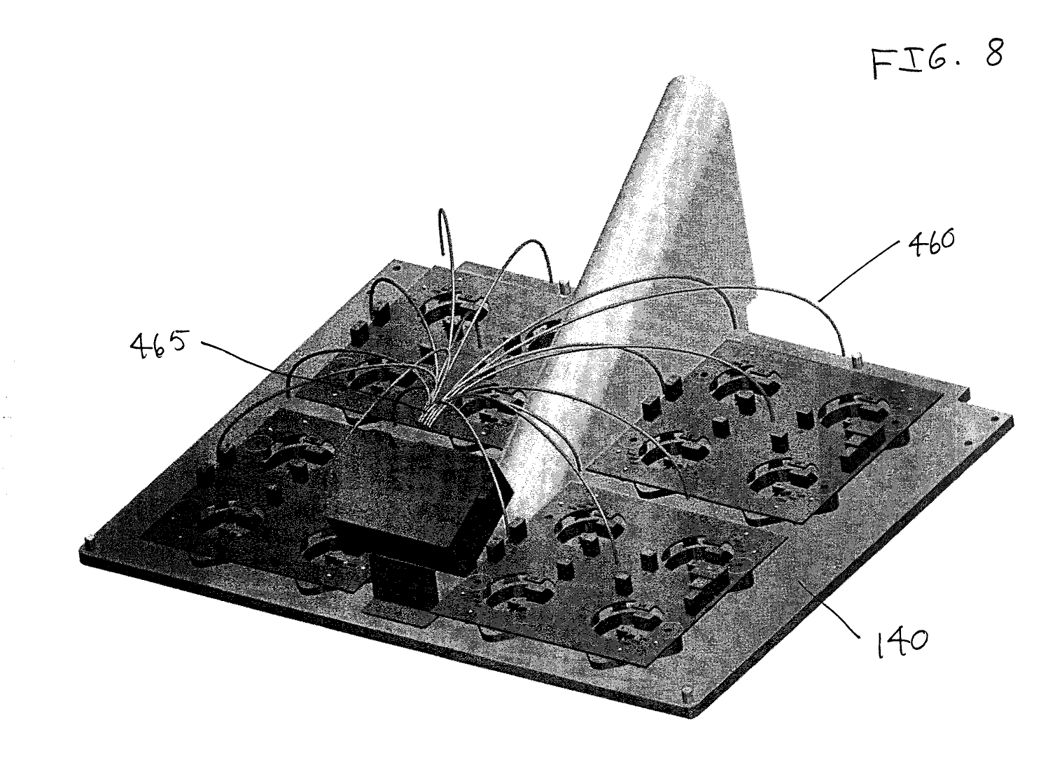

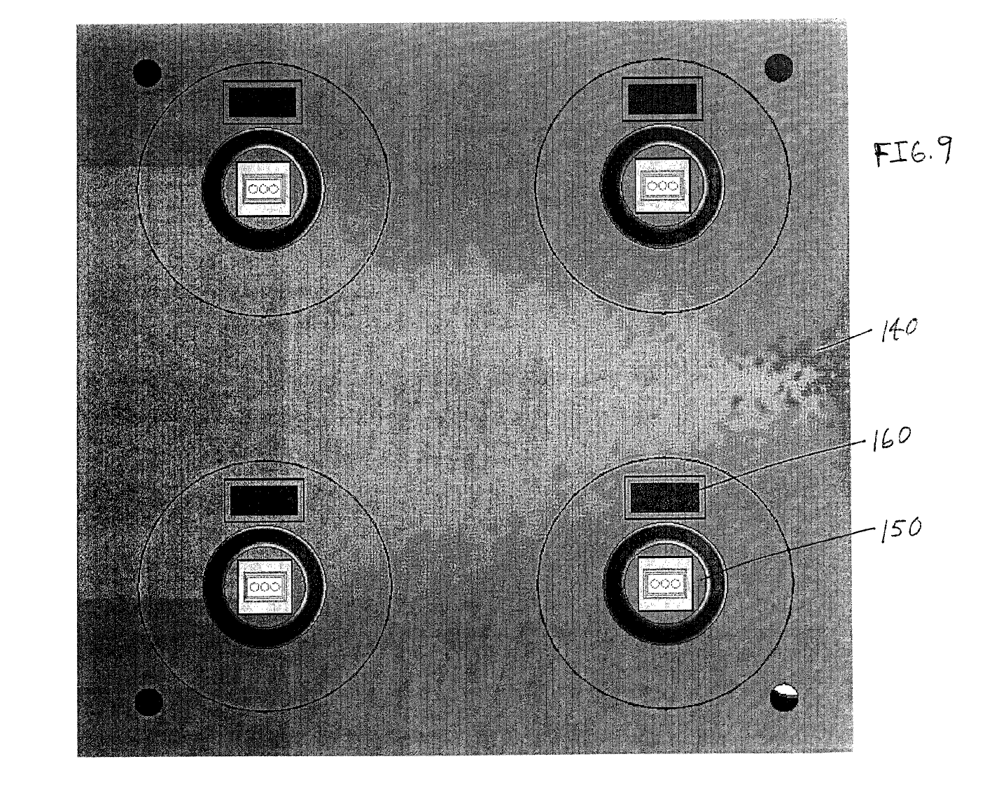

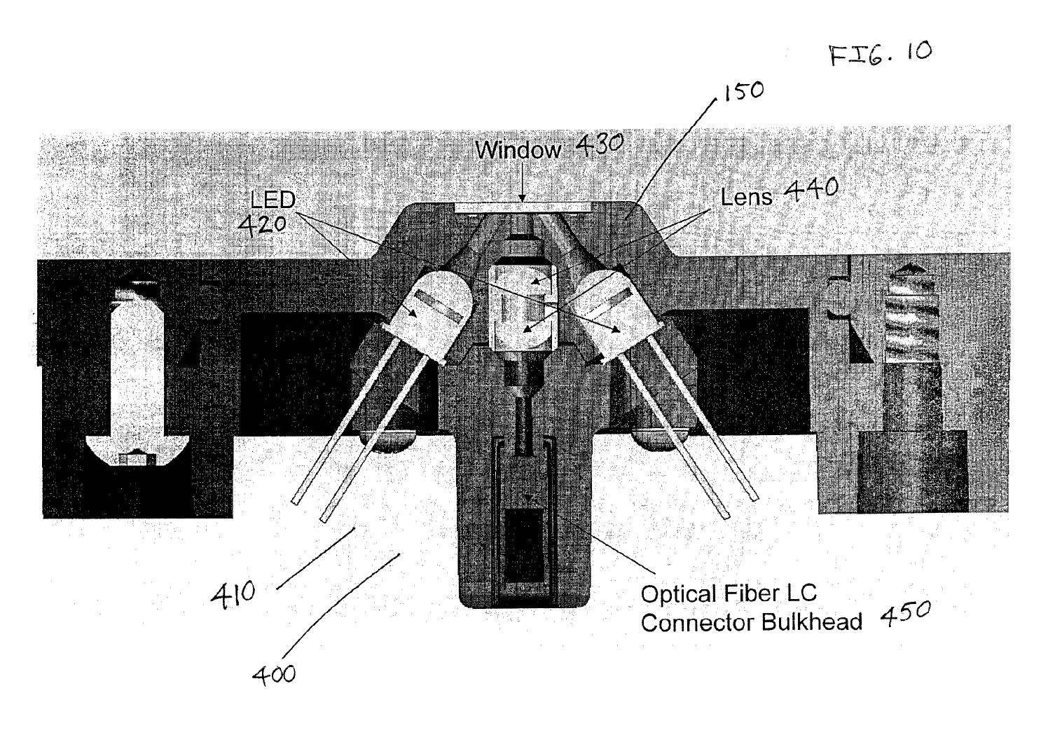

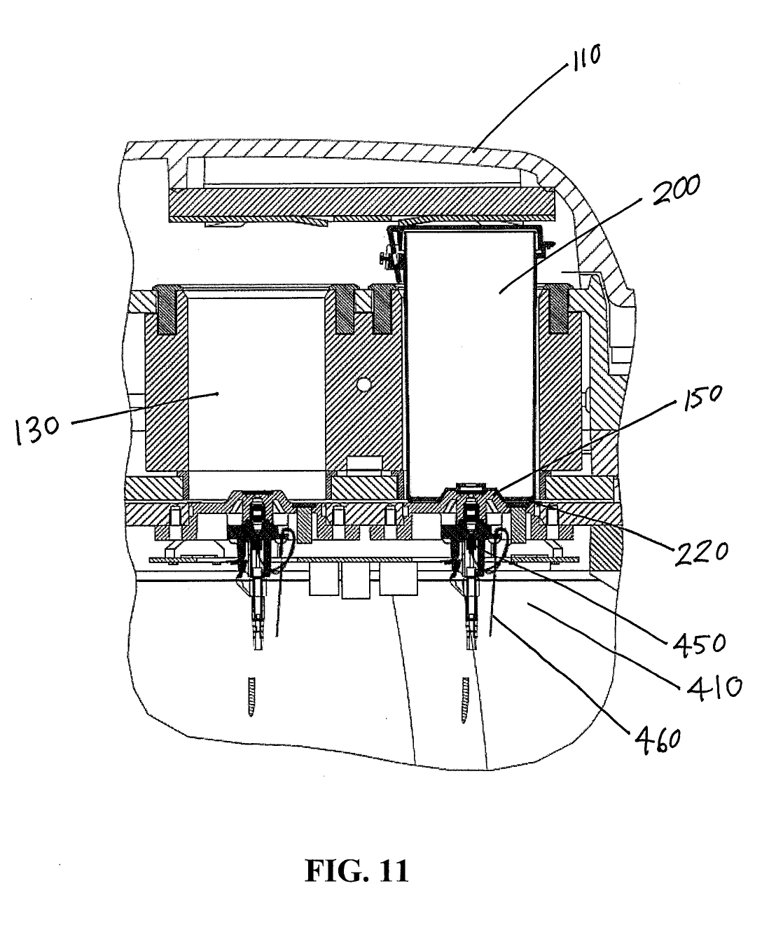

FIG. 7 is a front perspective view illustrating the upper surface of an optical board 140 of the test system 100 of FIG. 1 in accordance with an embodiment of the invention. FIG. 8 is a front perspective view illustrating the lower surface of the optical board 140 of FIG. 7 in accordance with an embodiment of the invention. FIG. 9 is a top view illustrating a portion of the upper surface of the optical board 140 of FIG. 7 in accordance with an embodiment of the invention. FIG. 10 is a cross sectional view illustrating a raised cartridge mount 150 of the optical board 140 of FIG. 7 in accordance with an embodiment of the invention. And, FIG. 11 is a partial cross sectional view illustrating a test cartridge 200 installed on a raised cartridge mount 150 in the test system 100 of FIG. 1 in accordance with an embodiment of the invention.

Below the mantel 120 is an optical board 140 which has a raised cartridge mount 150 for each incubator 130. The raised cartridge mount 150 mates with the base 220 of a test cartridge 200 as will be described below. Each raised cartridge mount 150 may have an infra-red sensor 160 to detect whether a test cartridge 200 is present.

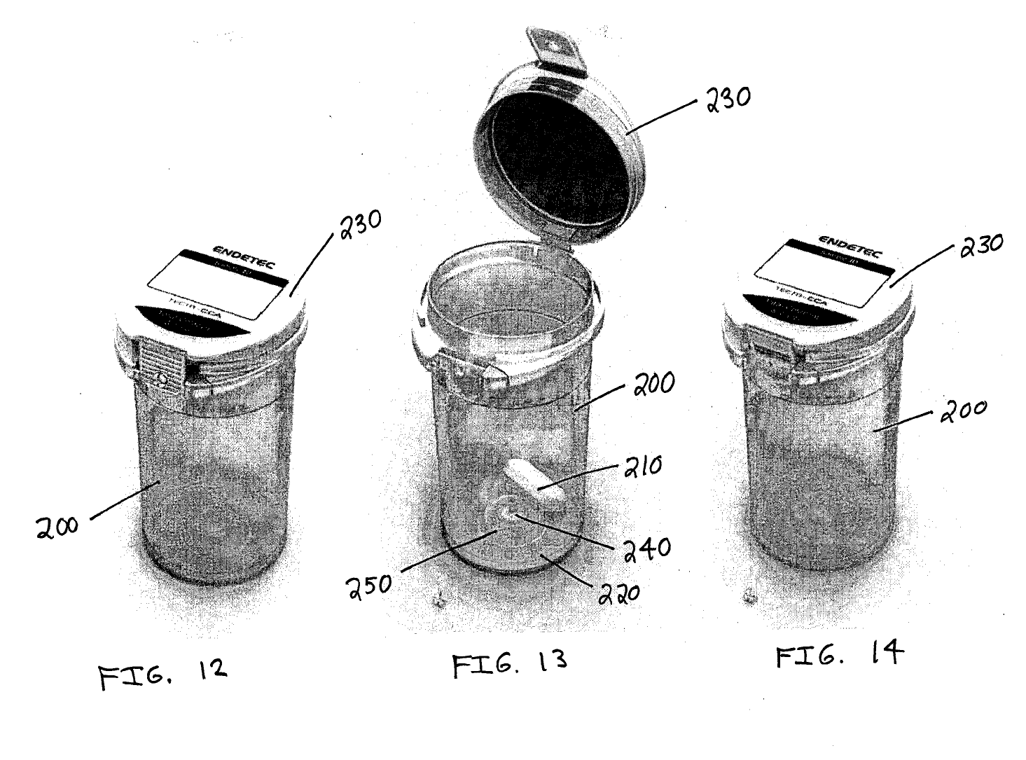

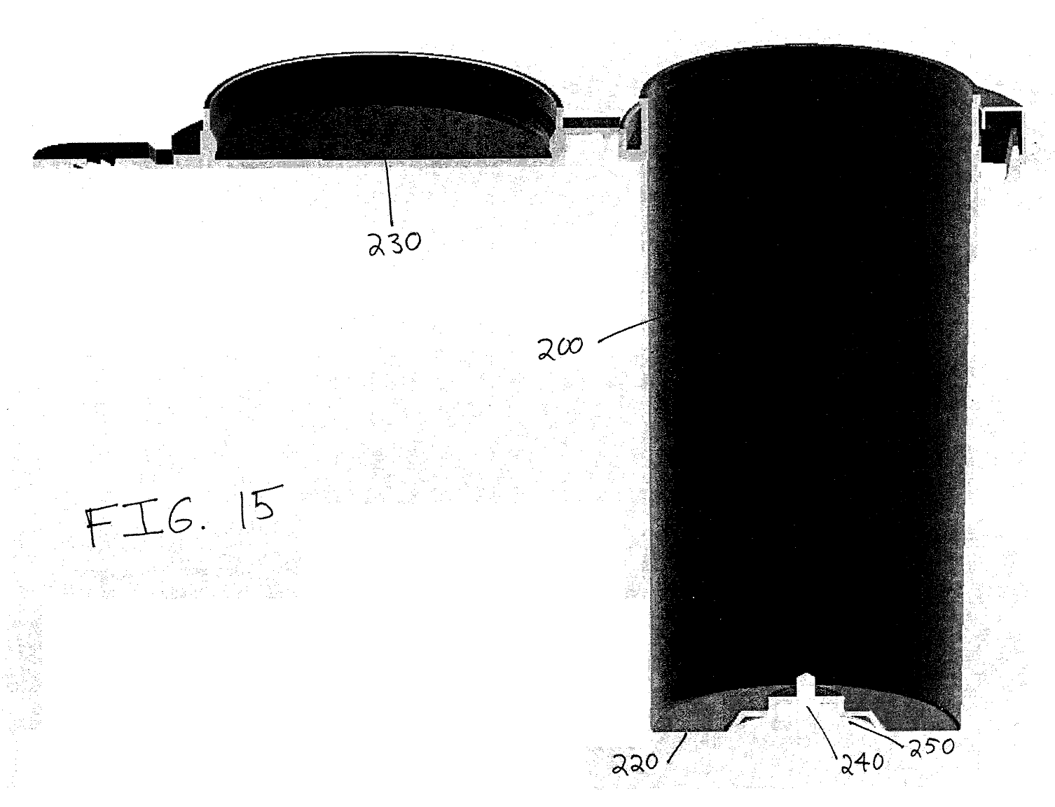

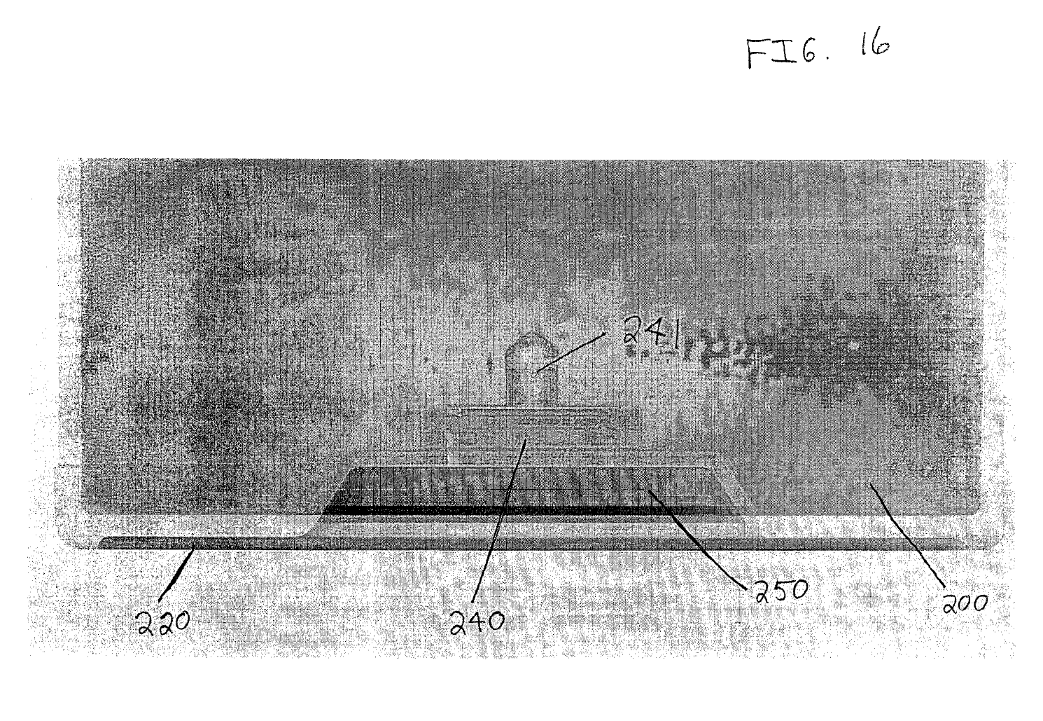

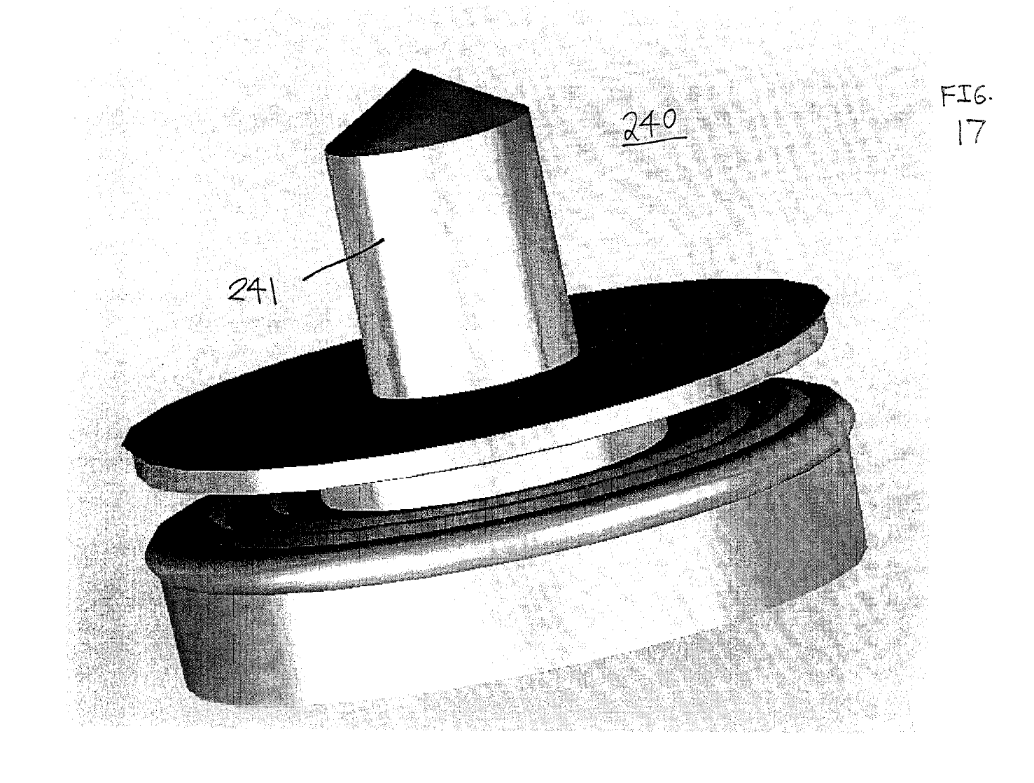

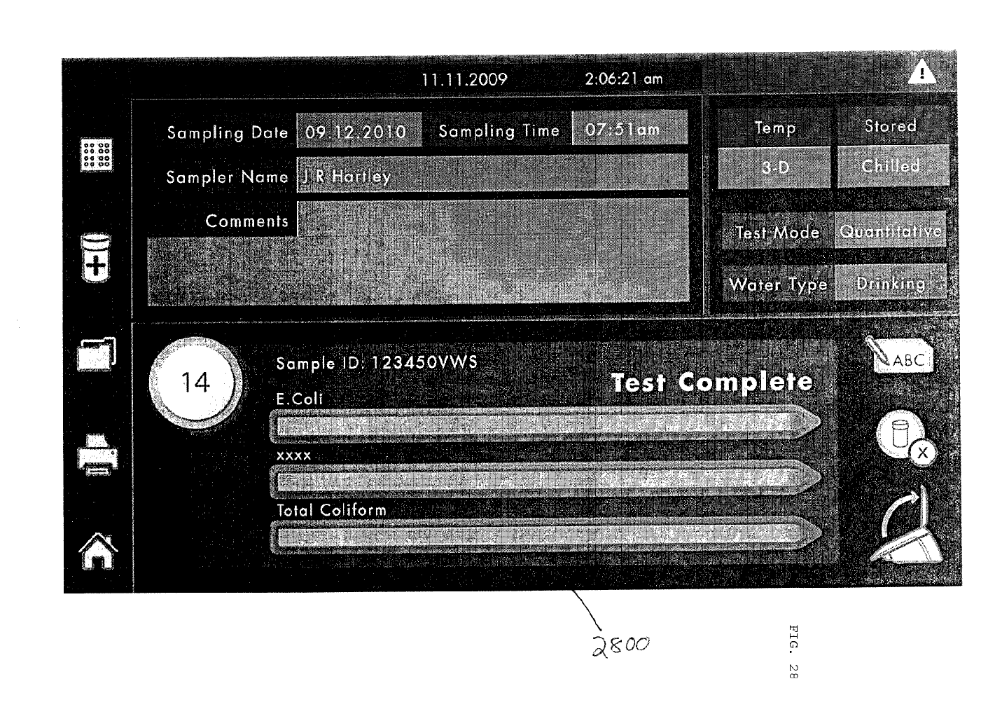

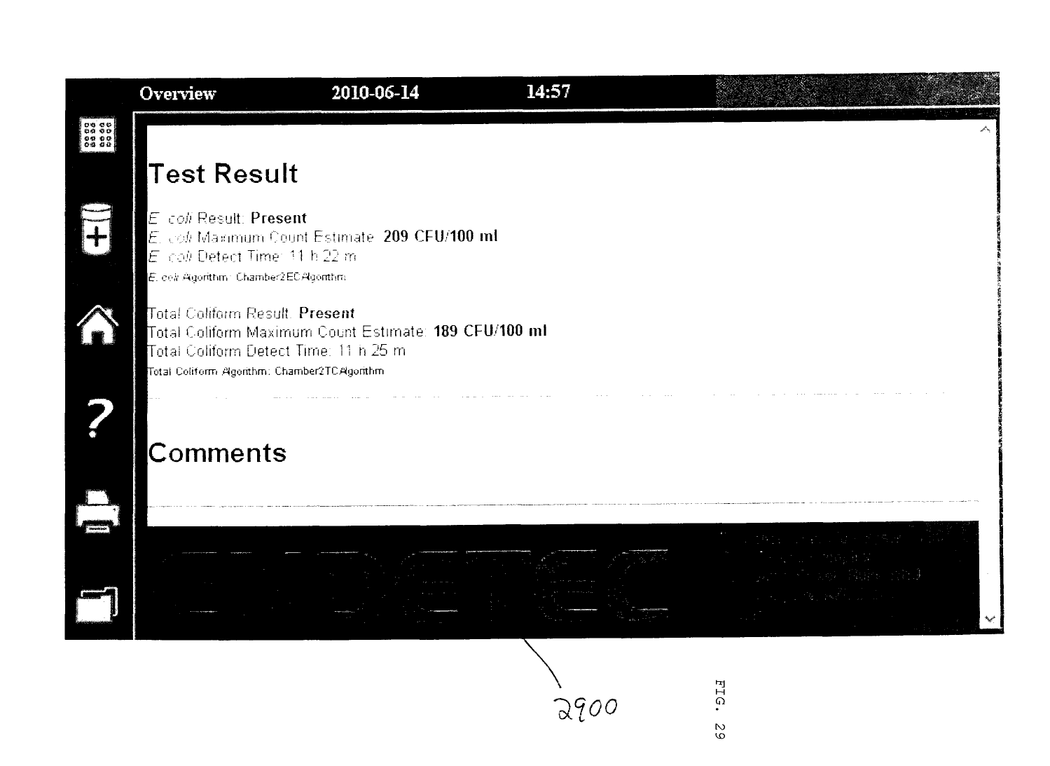

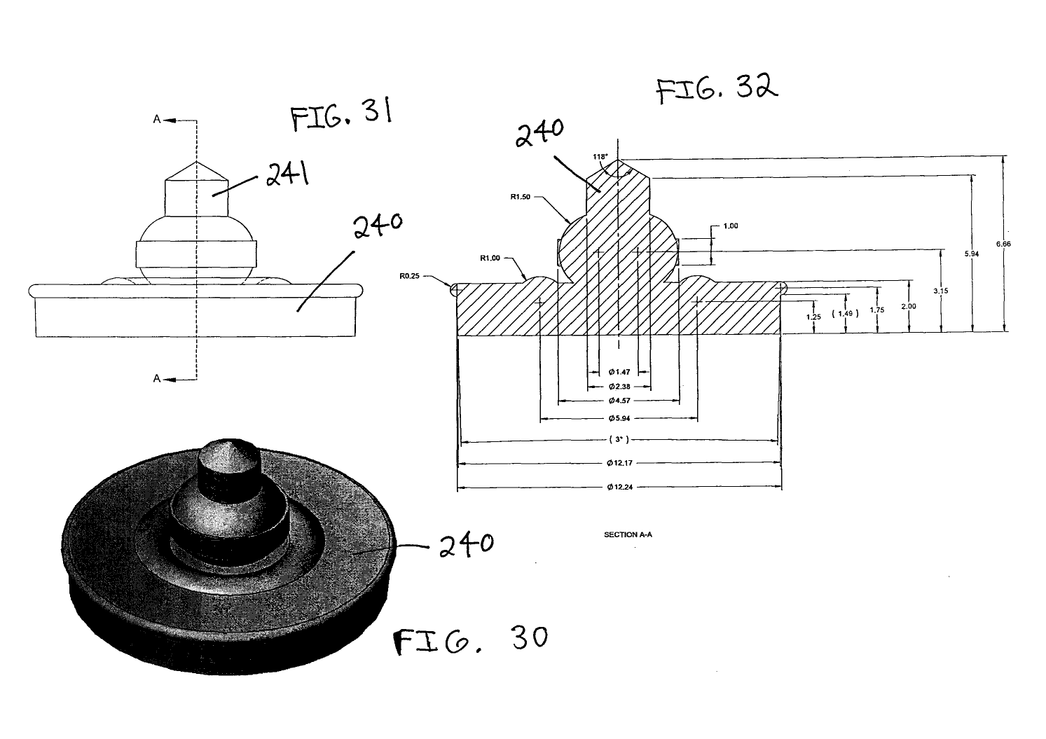

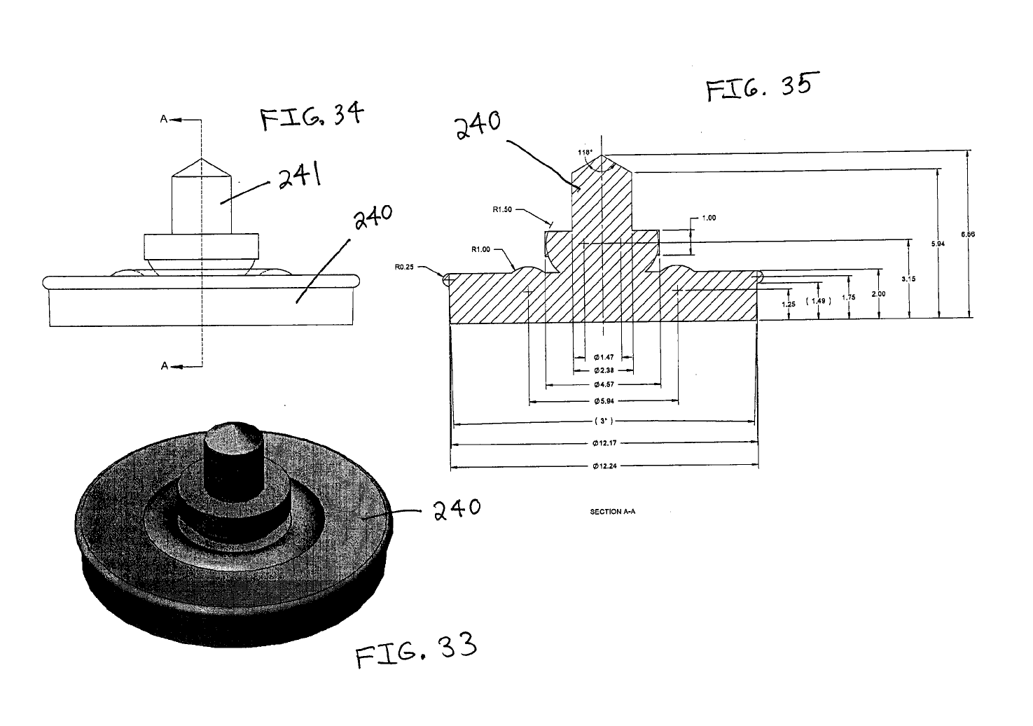

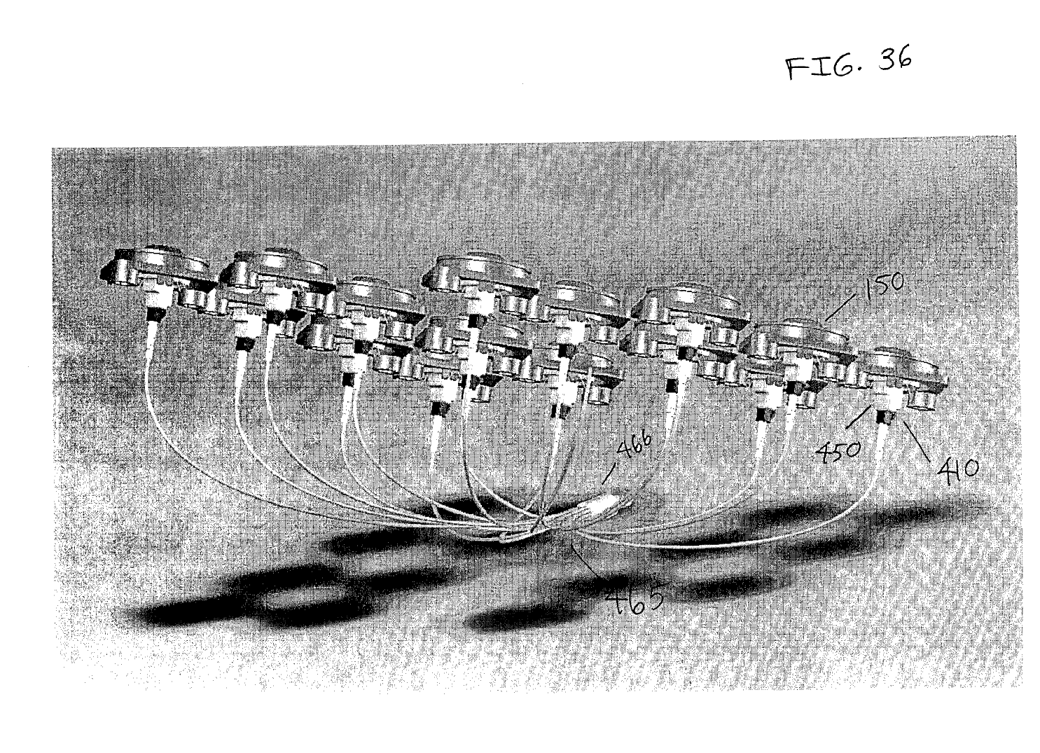

FIG. 12 is a front perspective view illustrating a test cartridge 200 with its lid 230 in a held closed position in accordance with an embodiment of the invention. FIG. 13 is a front perspective view illustrating the test cartridge 200 of FIG. 12 with its lid 230 in an opened position in accordance with an embodiment of the invention. FIG. 14 is a front perspective view illustrating the test cartridge 200 of FIG. 12 with its lid 230 in a locked closed position in accordance with an embodiment of the invention. FIG. 15 is a cross sectional view illustrating the test cartridge 200 of FIG. 12 with a partitioning element 240 installed in accordance with an embodiment of the invention. FIG. 16 is a cross sectional detail view illustrating the test cartridge 200 of FIG. 12 with a partitioning element 240 installed in accordance with an embodiment of the invention. FIG. 17 is a front perspective view of a partitioning element 240 in accordance with an embodiment of the invention. And, FIG. 18 is a front view of the partitioning element 240 of FIG. 17 in accordance with an embodiment of the invention. FIGS. 30-32 are perspective, front, and cross sectional views, respectively, illustrating an alternate partitioning element 240 in accordance with an embodiment of the invention. And, FIGS. 33-35 are perspective, front, and cross sectional views, respectively, illustrating an alternate partitioning element 240 in accordance with an embodiment of the invention.

Installed in the test cartridge 200 over a recess 250, mounted in the recess 250, molded into the recess 250, or snap fit into the recess 250 in the base 220 of the test cartridge 200 is a partitioning element 240. The partitioning element 240 may be a polymer partitioning element 240. The partitioning element 240 is in contact with the sample in the test cartridge 200 and is optically coupled to the optical system 400 described below.

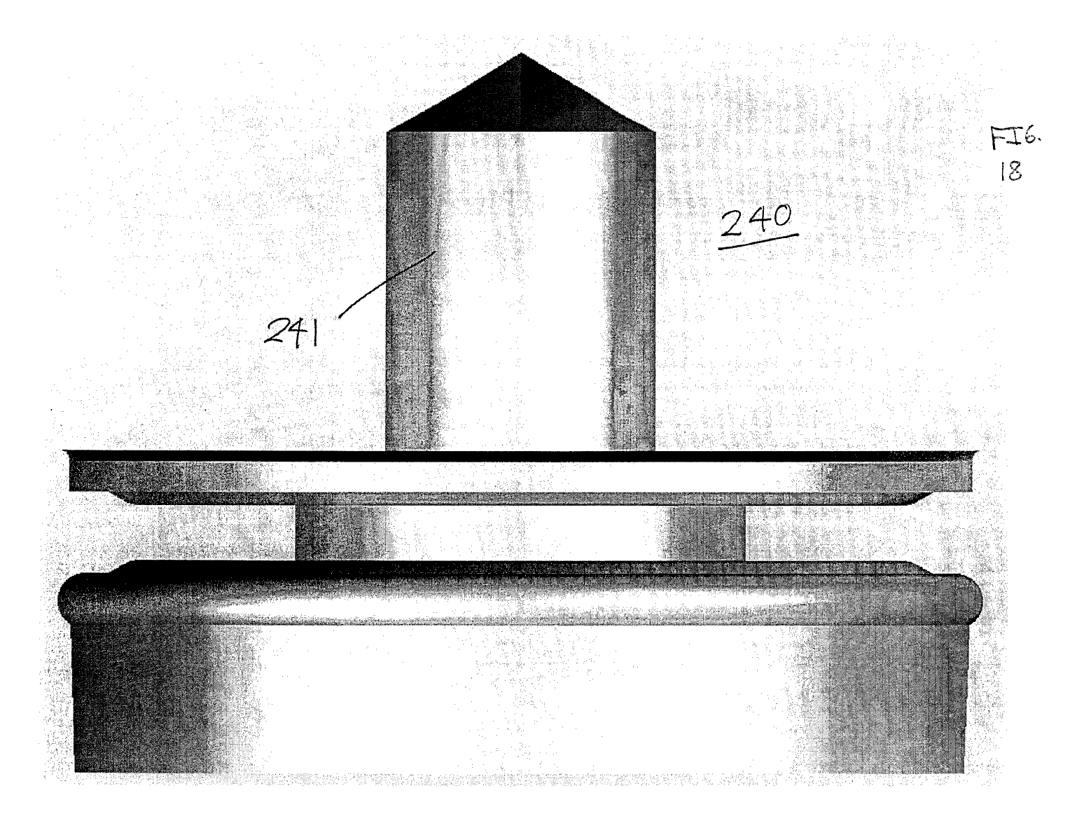

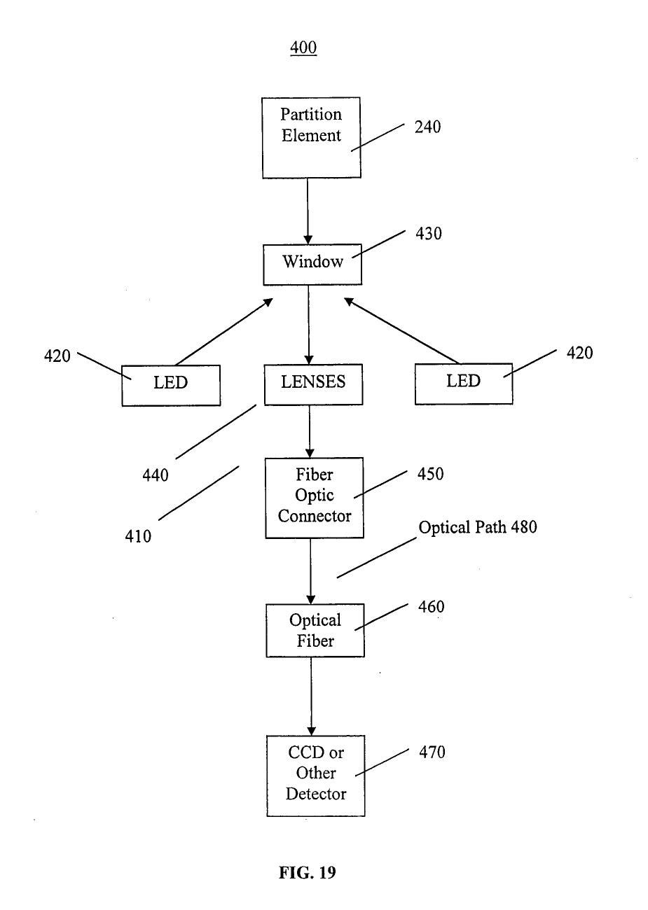

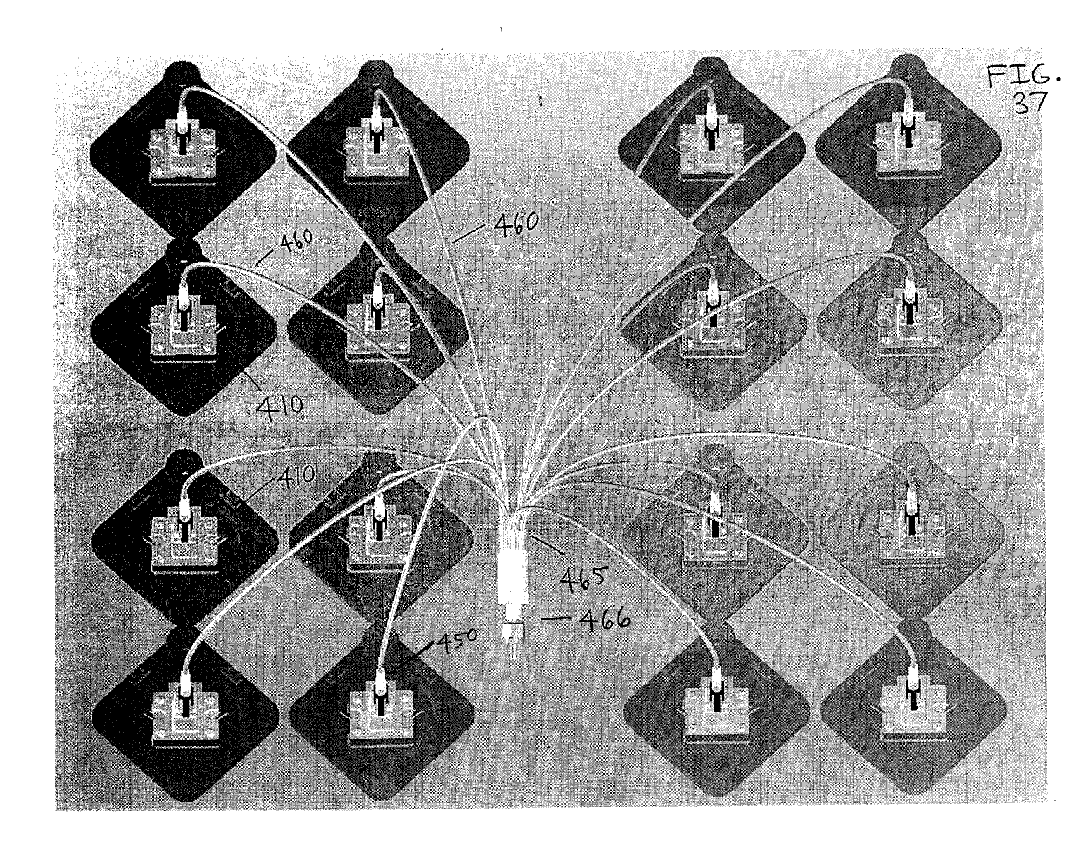

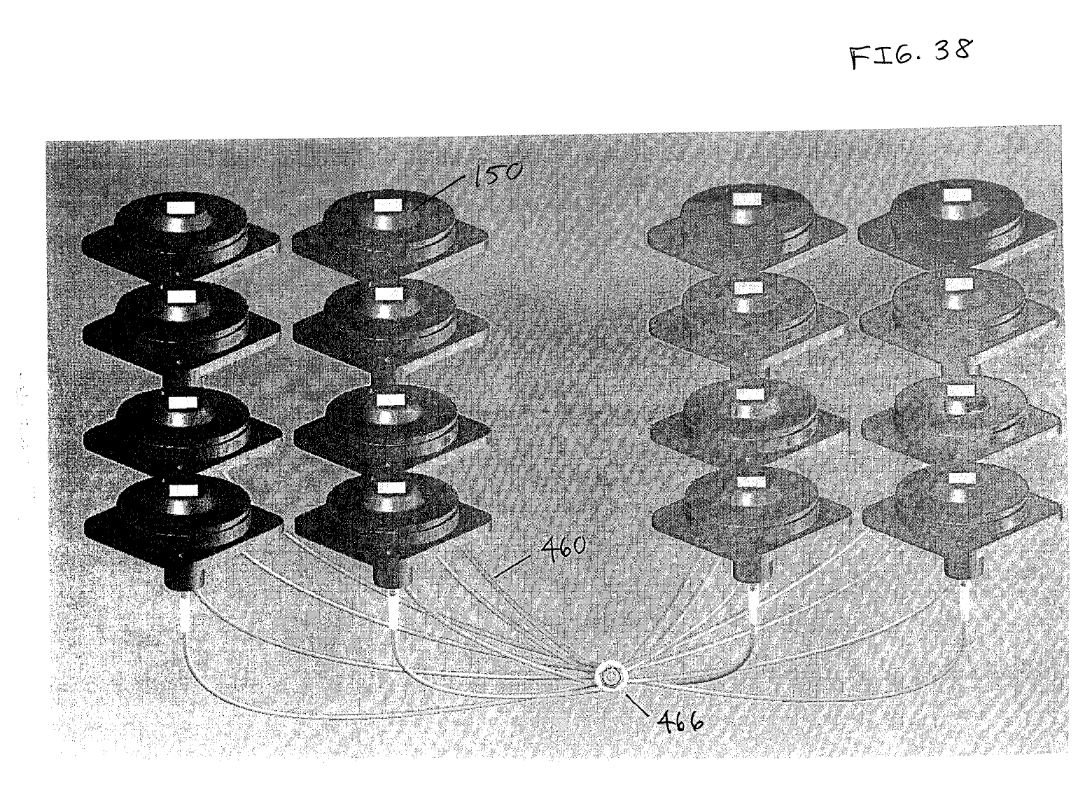

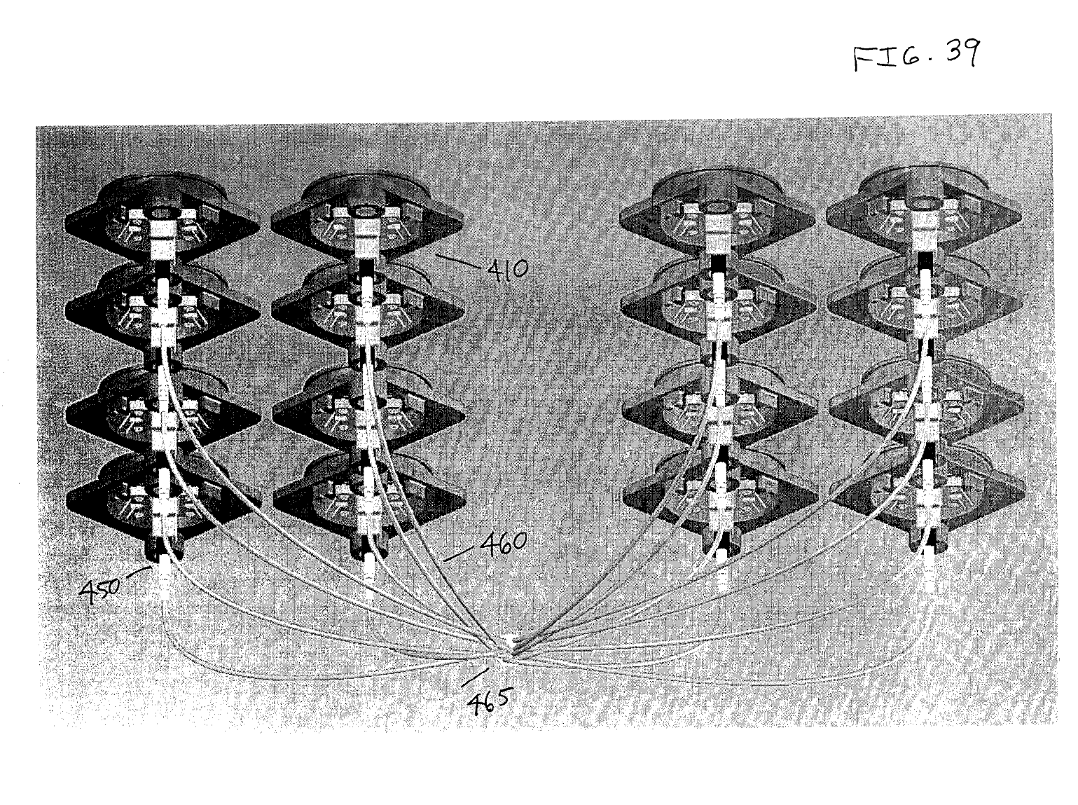

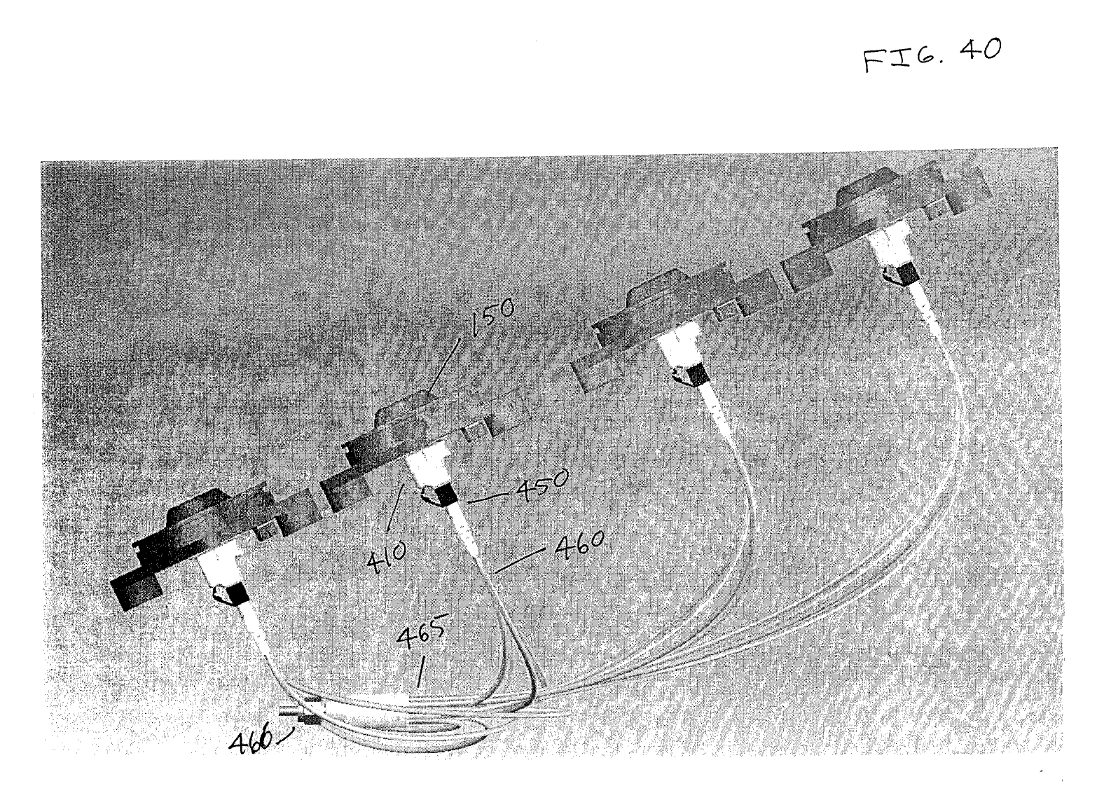

FIG. 19 is a block diagram illustrating an optical system 400 of the test system 100 in accordance with an embodiment of the invention. FIGS. 36-40 are perspective, bottom, front, rear, and side views, respectively, illustrating fiber optic bundling 465 in accordance with an embodiment of the invention.

The test system 100 includes an optical system 400 which may include the optical board 140. The optical system 400 is used to detect fluorescence in the partitioning element 240. The optical system 400 in combination with the raised cartridge mount 150 is designed to receive and/or optimize the fluorescence signal derived from the polymer partitioning element 240 in the test cartridge 200.

In particular, the raised cartridge mount 150 is designed to fit into a matched recess 250 formed in the base 220 of the test cartridge 200 to centre the polymer partitioning element 240 over an optical assembly 410 contained within the raised cartridge mount 150. The optical assembly 410 has one or more light emitting diode (“LED”) 420 light sources for fluorescence excitation. The LEDs 420 are mounted off axis and at an angle (e.g., at 65 degrees of arc) and positioned such that their light is projected into the protruding nub 241 of the polymer partitioning element 240. The angle is chosen so that the light propagates through the protruding nub 241 to illuminate its entire length. The angle and position are also set to reduce the intensity of excitation light from the LEDs 420 that is directly reflected into the detection optics of the assembly 410. Fluorescence from the partitioning element 240 follows an optical path 480 that passes through the window 430, lenses 440, fiber optic connector 450, optical fiber 460, and to an optical detector (e.g., a charged coupled device (“CCD”) based spectrometer) 470 of the optical system 400. The spectrometer 470 may contain additional components such as a diffraction grating which may be required for fluorescence detection. In one embodiment, two LEDs 420 are used in the assembly 410 to provide more excitation light, and therefore fluorescence signal, than provided by one LED 420. The lenses 440 are used to collect fluorescence from the partitioning element 240 and couple it to the optical fiber 460 for transmission to the detector 470.

According to one embodiment, a single detector 470 may be used to monitor several (e.g., sixteen) optical assemblies 410 by optically combining or bundling 465 the optical fibers 460 from each assembly 410 using a single fiber optic connector 466 at or leading to the detector 470.

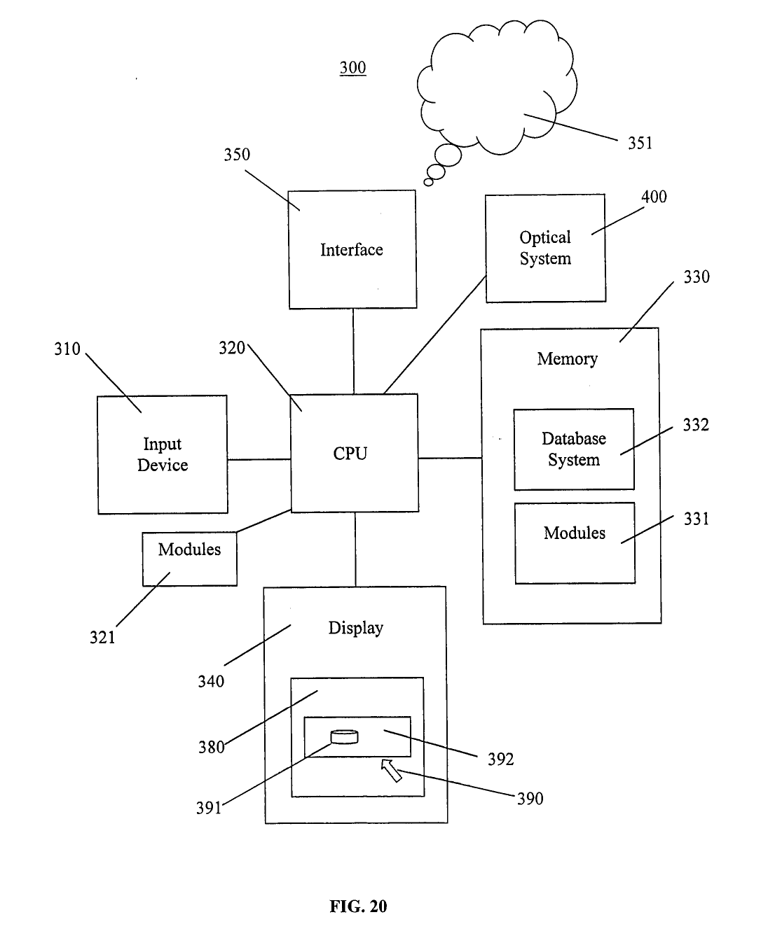

FIG. 20 is a block diagram illustrating a data processing system 300 of the test system 100 in accordance with an embodiment of the invention.

The optical system 400 is coupled to a data processing system 300 for analyzing data from the optical system 400 and for presenting test results to and for receiving commands from a user of the test system 100 via a graphical user interface (“GUI”) 380 displayed on a display 340 of the test system 100. The GUI 380 and test system 100 allow for the multiplexing detection of biological molecules in samples in several (e.g., 16) cartridges 200 using one detector 470. This may be performed, for example, by selectively illuminating only the LEDs 420 associated with a particular fiber 460 of the bundled fibers 465.

According to one embodiment, the data processing system 300 is suitable for controlling the test system 100 in conjunction with a GUI 380, as described below. The data processing system 300 may be a client and/or server in a client/server system. For example, the data processing system 300 may be a server system or a personal computer (“PC”) system. The data processing system 300 includes an input device 310, a central processing unit (“CPU”) 320, memory 330, a display 340, and an interface device 350. The input device 310 may include a keyboard, a mouse, a trackball, a touch sensitive surface or screen, or a similar device. The display 340 may include a computer screen, television screen, display screen, terminal device, a touch sensitive display surface or screen, or a hardcopy producing output device such as a printer or plotter. The memory 330 may include a variety of storage devices including internal memory and external mass storage typically arranged in a hierarchy of storage as understood by those skilled in the art. For example, the memory 330 may include databases, random access memory (“RAM”), read-only memory (“ROM”), flash memory, and/or disk devices. The interface device 350 may include one or more network connections. The data processing system 300 may be adapted for communicating with other data processing systems (e.g., similar to data processing system 300) over a network 351 via the interface device 350. For example, the interface device 350 may include an interface to a network 351 such as the Internet and/or another wired or wireless network (e.g., a wireless local area network (“WLAN”), a cellular telephone network, etc.). Thus, the data processing system 300 may be linked to other data processing systems by the network 351. The CPU 320 may include or be operatively coupled to dedicated coprocessors, memory devices, or other hardware modules 321. The CPU 320 is operatively coupled to the memory 330 which stores an operating system (e.g., 331) for general management of the system 300. The CPU 320 is operatively coupled to the input device 310 for receiving user commands or queries and for displaying the results of these commands or queries to the user on the display 340. Commands and queries may also be received via the interface device 350 and results may be transmitted via the interface device 350. The data processing system 300 may include a database system 332 (or store) for storing data and programming information. The database system 332 may include a database management system and a database and may be stored in the memory 330 of the data processing system 300. In general, the data processing system 300 has stored therein data representing sequences of instructions which when executed cause the method described herein to be performed. Of course, the data processing system 300 may contain additional software and hardware a description of which is not necessary for understanding the invention.

Thus, the data processing system 300 includes computer executable programmed instructions for directing the system 300 to implement the embodiments of the present invention. The programmed instructions may be embodied in one or more hardware modules 321 or software modules 331 resident in the memory 330 of the data processing system 300 or elsewhere (e.g., 320). Alternatively, the programmed instructions may be embodied on a computer readable medium (or product) (e.g., a compact disk (“CD”), a floppy disk, etc.) which may be used for transporting the programmed instructions to the memory 330 of the data processing system 300. Alternatively, the programmed instructions may be embedded in a computer-readable signal or signal-bearing medium (or product) that is uploaded to a network 351 by a vendor or supplier of the programmed instructions, and this signal or signal-bearing medium may be downloaded through an interface (e.g., 350) to the data processing system 300 from the network 351 by end users or potential buyers.

A user may interact with the data processing system 300 and its hardware and software modules 321, 331 using a graphical user interface (“GUI”) 380. The GUI 380 may be used for controlling, monitoring, managing, and accessing the data processing system 300 and test system 100. GUIs are supported by common operating systems and provide a display format which enables a user to choose commands, execute application programs, manage computer files, and perform other functions by selecting pictorial representations known as icons, or items from a menu through use of an input device 310 such as a mouse or touch screen. In general, a GUI is used to convey information to and receive commands from users and generally includes a variety of GUI objects or controls, including icons, toolbars, drop-down menus, text, dialog boxes, buttons, and the like. A user typically interacts with a GUI 380 presented on a display 340 by using an input device (e.g., a mouse or touchscreen) 310 to position a pointer or cursor 390 over an object (e.g., an icon) 391 and by “clicking” on the object 391. Typically, a GUI based system presents application, system status, and other information to the user in one or more “windows” appearing on the display 340. A window 392 is a more or less rectangular area within the display 340 in which a user may view an application or a document. Such a window 392 may be open, closed, displayed full screen, reduced to an icon, increased or reduced in size, or moved to different areas of the display 340. Multiple windows may be displayed simultaneously, such as: windows included within other windows, windows overlapping other windows, or windows tiled within the display area.

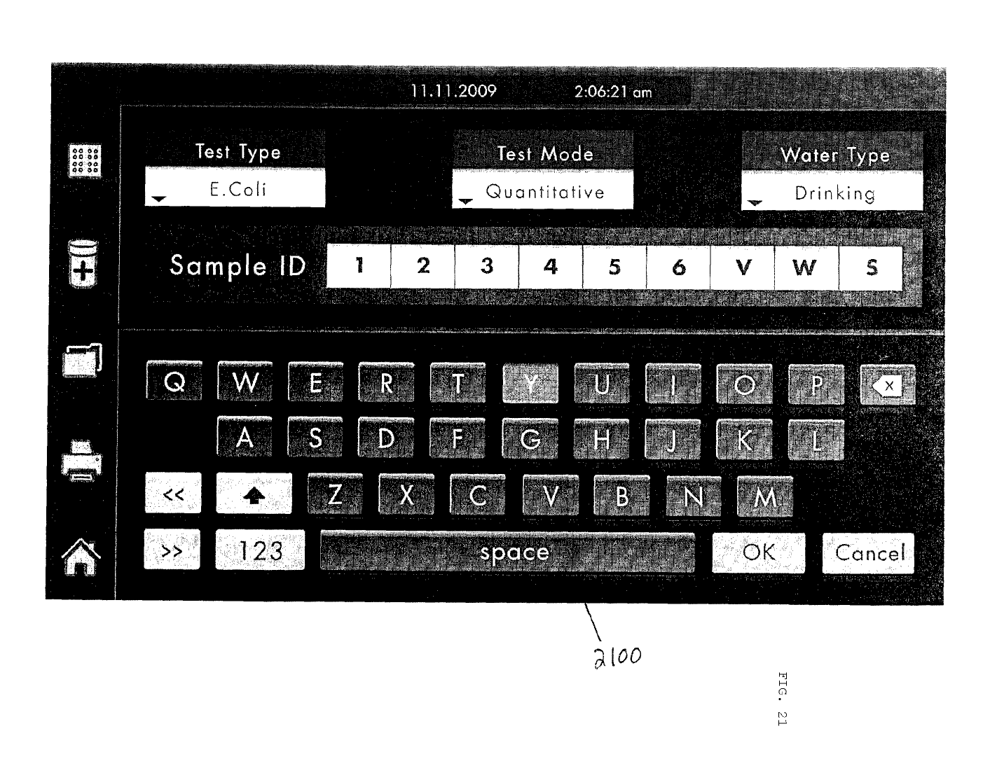

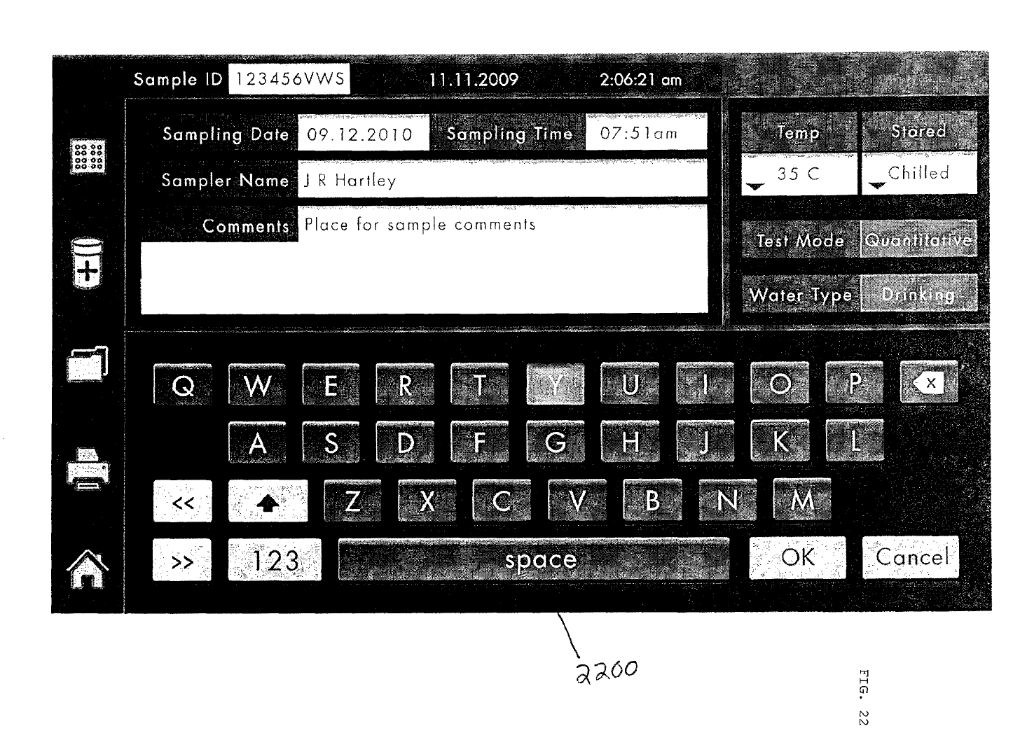

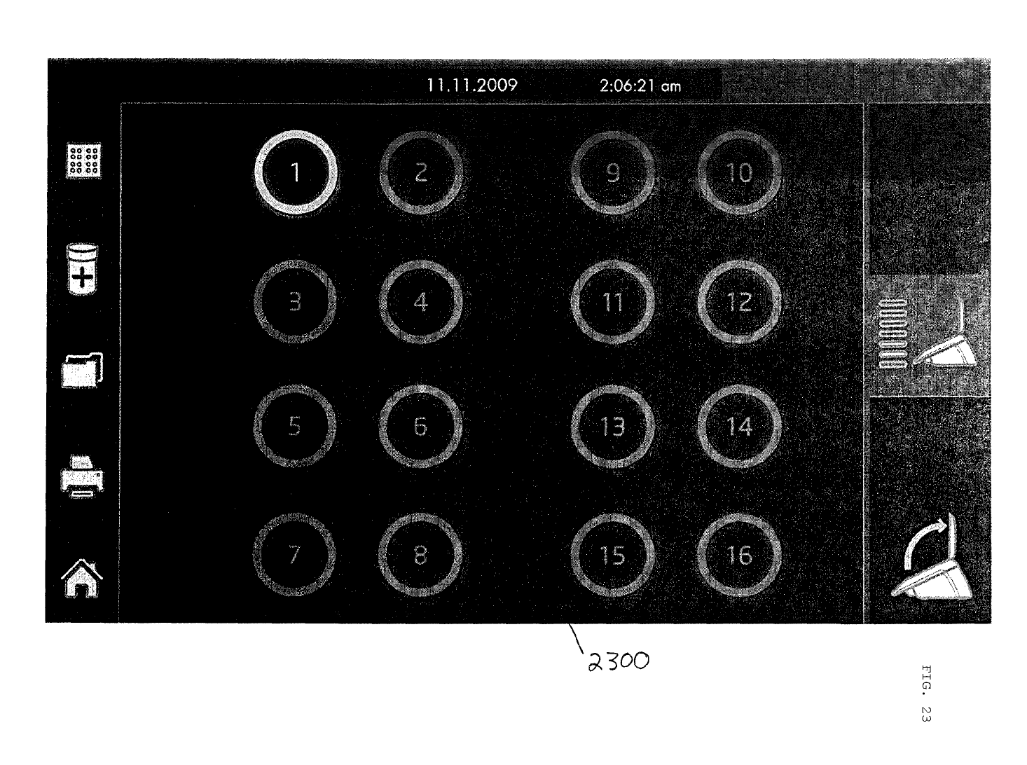

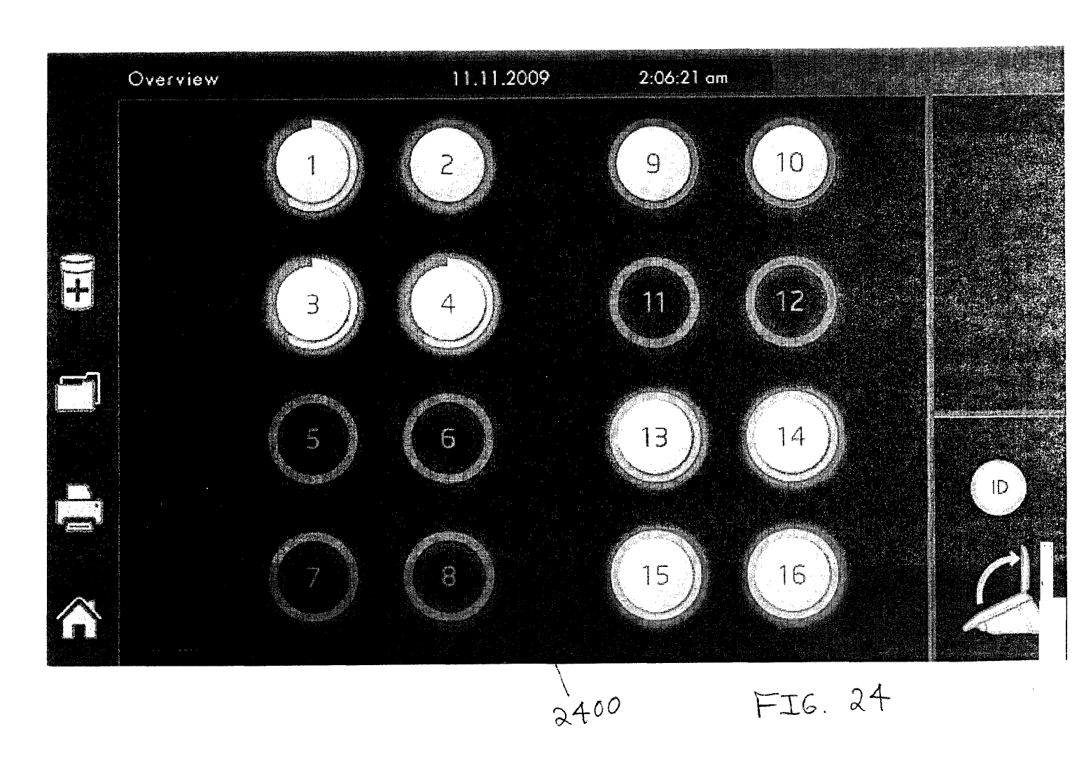

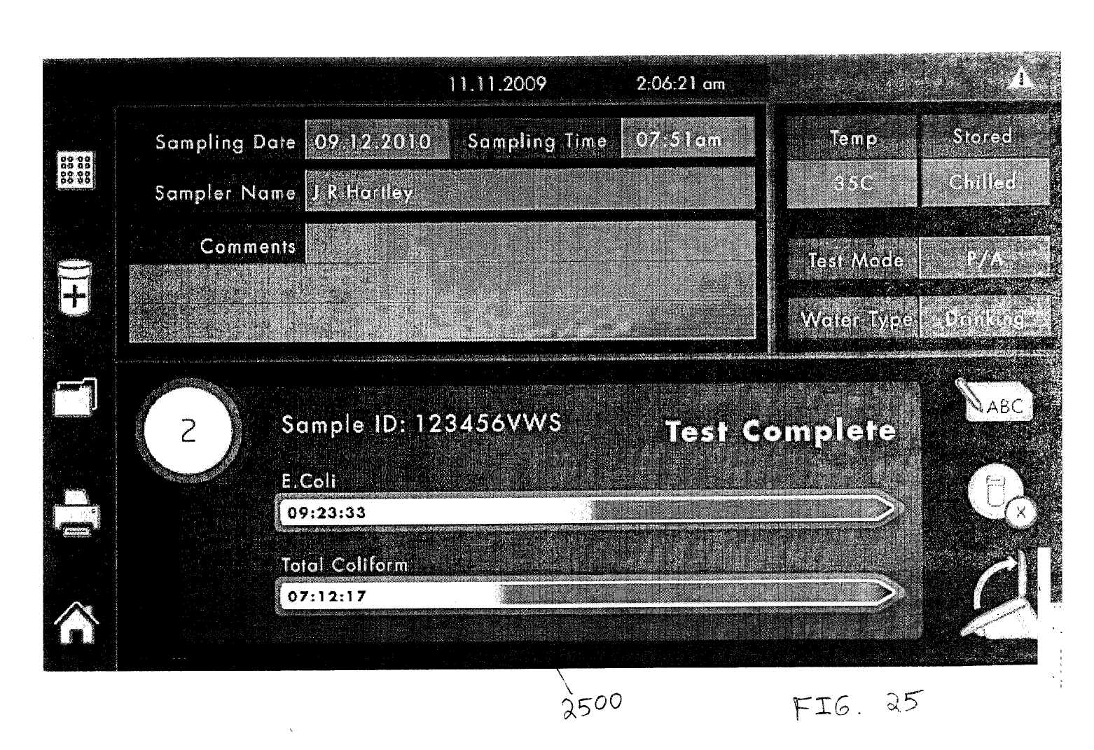

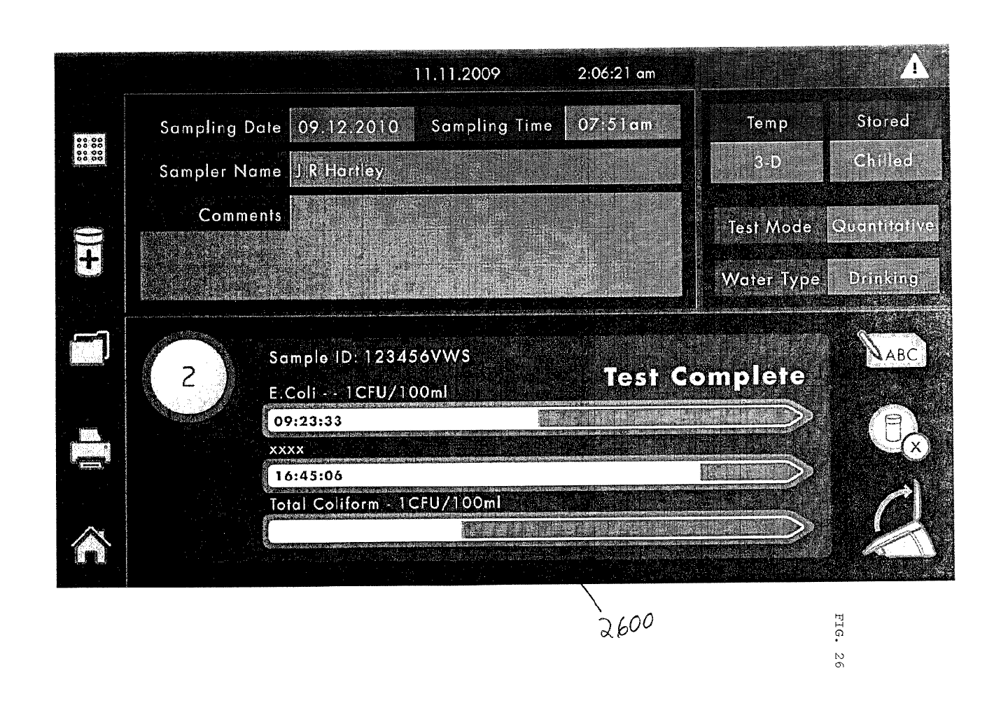

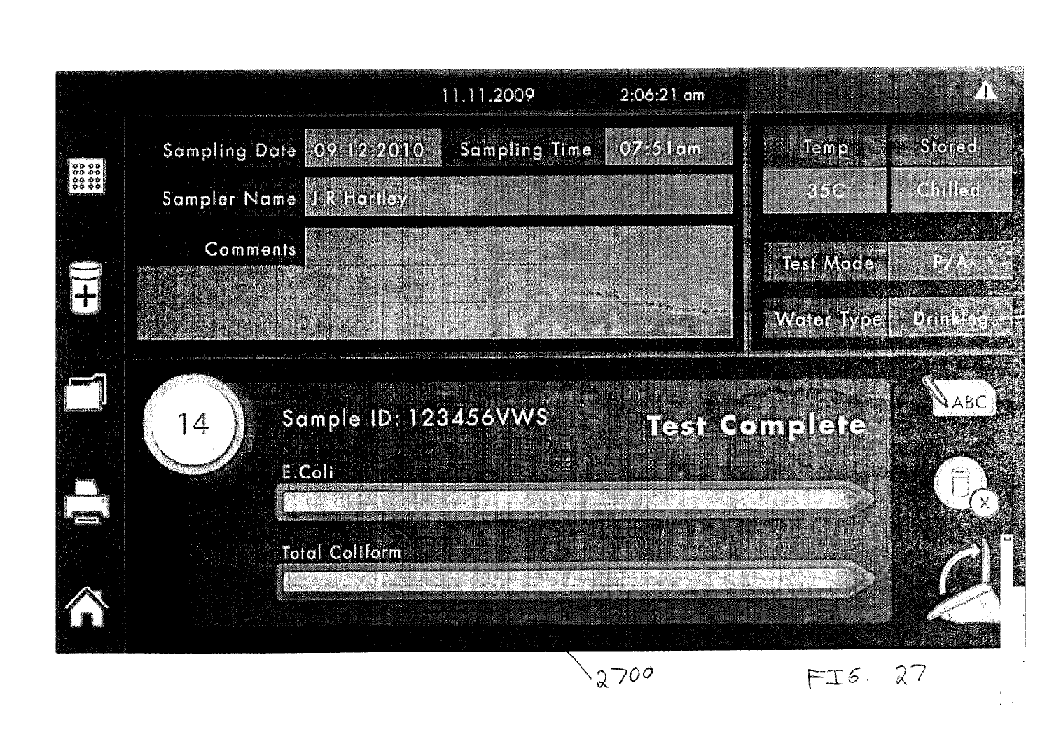

FIG. 21 is a screen capture illustrating a input screen 2100 of a graphical user interface (“GUI”) 380 of the test system 100 in accordance with an embodiment of the invention. FIG. 22 is a screen capture illustrating a second input screen 2200 of a GUI 380 of the test system 100 in accordance with an embodiment of the invention. FIGS. 23 and 24 are screen captures illustrating test status screens 2300, 2400 of a GUI 380 of the test system 100 in accordance with an embodiment of the invention. FIGS. 25 and 26 are screen captures illustrating positive test result screens 2500, 2600 of a GUI 380 of the test system 100 in accordance with an embodiment of the invention. FIGS. 27 and 28 are screen captures illustrating negative test result screens 2700, 2800 of a GUI 380 of the test system 100 in accordance with an embodiment of the invention. And, FIG. 29 is a screen capture illustrating an alternate test result screen 2900 of a GUI 380 of the test system 100 in accordance with an embodiment of the invention.

The screen captures of FIGS. 21-29 show various input, status, and reporting screen presentations associated with the GUI 380 of the data processing system 300 of the test system 100.

Thus, according to one embodiment, there is provided a method and system 100 for the reliable and rapid detection of biological molecules associated with enzyme activity. The invention is applicable to the detection of biological molecules associated with enzyme activity of biological contaminants, such as microorganisms. One practical application of the invention therefore relates to the detection of biological contaminants in samples such as water and food, where rapid detection is critical to preventing the spread of contamination and infection of individuals through consumption of contaminated water or food. Another practical application of the invention is use in assays, such as enzyme-linked immunosorbent assay (“ELISA”), for determination of enzyme labels.

In particular, the invention provides for reliable and rapid detection of enzyme activity. According to the invention, target enzyme activity is detected by providing to an enzyme a substrate comprising a fluorophore, and selectively detecting fluorescence of a fluorescent product of the enzyme-substrate reaction at a very low product concentration. Alternatively, target enzyme activity is detected by providing to an enzyme a substrate comprising a fluorophore, and selectively detecting fluorescence of the substrate and its rate of decrease as the enzyme-substrate reaction proceeds. Selective detection of the fluorescent product or substrate is achieved by providing an optical system 400 and a partitioning element 240, wherein one of the product or substrate 210 is partitioned into the partitioning element 240. The optical system 400 includes suitable optical hardware for detecting fluorescence of the product or substrate partitioned into the partitioning element 240.

The ability to detect a product of the enzyme-substrate interaction at a very low product concentration or a minute change in substrate concentration translates into rapid detection because of the short time required to produce only a small amount of the product, or remove a small amount of substrate. In embodiments in which the presence of microorganisms is detected, therefore, only a small number of microorganisms, and hence a short incubation period, is required for detection. While the invention is described primarily with respect to the detection of enzyme-substrate product, it will be understood that the invention is equally applicable to the detection of substrate.

Detection of enzyme activity according to the invention can be carried out in any medium where target enzymes are active, and which is sufficiently fluid to allow for partitioning of a molecule of interest, such as a product of the enzyme-substrate reaction, into the partitioning element 240. Suitable media are aqueous, and may be fluids (e.g., liquids) or semi-solids (e.g., biological tissues, gels). Generally, the invention is used to detect a target enzyme in a sample, such as, for example, water, food, biological samples such as tissues and bodily fluids, and soil. Analysis of some samples, such as certain food, biological, and soil samples, requires that the sample be combined with a suitable medium.

According to one embodiment, there is provided a method of detecting biological molecules associated with enzyme activity in a sample. The method comprises combining a target enzyme or a biological contaminant associated with the target enzyme and a substrate, irradiating the combination with excitation light (i.e., light of a wavelength which produces fluorescence in either or both the substrate and product), and selectively detecting fluorescence of either the substrate or any product of the enzyme-substrate reaction when partitioned into the partitioning element. Preferably, fluorescence of a fluorescent product of the enzyme-substrate reaction is detected. Where the sample is not substantially a liquid or semi-liquid (e.g., a gel), it is preferable that the substrate and sample are combined in a solution. Suitable solutions include any solution which can support and/or promote enzyme activity. Where cells are employed, a suitable solution may be, for example, an appropriate medium (i.e., “broth”) selected to support and promote growth of the cells under investigation. For cells and most enzymes, such solutions are aqueous. The product of the enzyme-substrate reaction can be, for example, a free fluorescent (dye) molecule, the fluorescence of which is detected.

According to one embodiment, fluorescence is detected by an optical system 400 which distinguishes between the product and the substrate, such that only fluorescence of the product or the substrate is detected. In particular, fluorescence of substantially only one of the product or the substrate is detected by providing a partitioning element 240 that allows for partitioning of either the product or the substrate therein. Fluorescence of the product or the substrate is detected when the product or substrate is partitioned into the partitioning element. When coupled to a suitable device for measuring fluorescence (i.e., light), such as, for example, a spectrometer or a filter photometer (e.g., 470) included within the optical system 400, the partitioning element 240 and optical system 400 produce a signal having a magnitude which varies predictably (e.g., linearly) with the intensity of the fluorescence, which is a function of the product or substrate concentration. According to one embodiment, the combination of substrate, product, and partitioning element 240 is chosen such that the substrate is not detected and the product is detected at the lowest possible concentration.

It will be appreciated that the invention can be applied to detection of activity of any enzyme, provided that (1) a substrate for such target enzyme can be conjugated with a fluorophore, (2) the target enzyme-substrate reaction produces a fluorescent product, and (3) the fluorescent product can be selectively detected with a partitioning element 240 and optical system 400 of the invention. For enzymes which cleave chemical bonds, the substrate must contain a moiety which binds to the enzyme, and be conjugated to the fluorescent product through a bond which the enzyme will cleave. For other enzyme reactions, such as some peroxidase reactions in which there is only chemical conversion of the substrate to give the product, suitable substrates are those which provide for the product being partitioned into the partitioning element 240.

It will be appreciated that the invention can be used to detect the presence of more than one enzyme, which may correspond to more than one species or strain of microorganism, simultaneously. This requires the use of a substrate suitable for each enzyme under consideration. If the fluorescent products of each different enzyme-substrate reaction fluoresce at different wavelengths, then activity of each enzyme under consideration can be detected. Alternatively, if the fluorescent products of each different enzyme-substrate reaction fluoresce at the same wavelength, then activity of at least one of the enzymes can be detected.

According to one embodiment, there is provided a partitioning element 240 and an optical system 400 for selectively-detecting fluorescent molecules. In particular, the partitioning element 240 provides for partitioning of molecules into the element, wherein detected fluorescence is predominantly that of molecules partitioned into the element. Such partitioning of molecules is achieved by disposing in a test cartridge 200 a partitioning element 240 and detecting fluorescence with an optical system 400. The partitioning element 240 allows only a molecule of interest to be partitioned therein.

For example, to detect enzyme activity using a fluorogenic substrate and fluorescent enzyme-substrate product, the invention provides a partitioning element 240 which allows for only the substrate or product molecules to partition therein, such that fluorescence of either the substrate or the product is detected by the optical system 400. Thus, it matters not whether both the substrate and the product are fluorescent, as the optical system 400 detects fluorescence from only one of the two. Enzyme activity can then be determined by measuring the rate of disappearance of substrate fluorescence, or the rate of appearance of product fluorescence. According to one embodiment, product molecules are partitioned into the partitioning element 240, and enzyme activity is determined by measuring the rate of appearance of product fluorescence. As noted above, detection of enzyme activity according to the invention can be carried out in any medium where target enzymes are active. Generally, such media are aqueous, and they may be fluids (e.g., liquids) or semi-solids (e.g., biological tissues, gels).

According to one embodiment, there is provided a test system 100 that employs a test cartridge 200 with an integrated partitioning element 240 that is capable of delivering presence/absence and bacteriological count estimation for a wide variety of pathogens, including, but not limited to, E. coli and total coliform bacteria. According to one embodiment, the test cartridge 200 is a disposable, single use cartridge. The test system 100 uses a test cartridge 200 with integral partitioning element 240 in which individual samples are contained. The optical system 400 of the test system 100 is external to the test cartridge 200. The partitioning element 240 does not contact multiple samples thereby reducing a potential source of cross-contamination between samples. This reduces the need to clean elements of the optical system 400 between tests. According to one embodiment, the test system 100 includes a calibration method based on multiple fluorophores that provides continuous optical path integrity monitoring and self-calibration. The test system 100 optionally provides for performing multiple tests for different pathogens.

The test cartridge 200 incorporates elements necessary to conduct a bacteriological test for a specific target pathogen, including but not limited to E. coli and total coliform bacteria. The test cartridge 200 includes a sealable casing or body enclosing a sterile interior that can be manipulated by simple mechanics in the test system 100. The partitioning element 240 and a test medium in either solid, powdered, or liquid form are contained within the body of the test cartridge 200. The test medium includes one or more substrate materials (e.g., 210), for example, glucuronide or galactoside substrate materials, each substrate material including a target fluorophore. The test medium may also comprise an additional (or second) fluorophore (i.e., a calibration fluorophore) that dissolves in an aqueous environment to provide a baseline optical signal for calibration and monitoring of optical signal path integrity, and a growth medium to support growth of the target organism(s). The test medium may optionally include: sodium thiosulfate to remove free chlorine from a water sample; antibiotic to inhibit growth of non-target microorganisms; and, a compound that reacts in the presence of the target pathogen to produce a colour change as visual confirmation of the presence of the target pathogen in the sample.

The test system 100 includes an optical system 400 for detecting the fluorophore of interest (e.g., a fluorophore produced upon degradation of the substrate by target enzyme action). The optical system 400 together with the partitioning element 240 function on the principles described above. Thus, the optical system 400 includes a light source 420, such as a UV light source or LEDs, for irradiating the partitioning element 240 of the test cartridge 200, and an optical detector such as a CCD detector 470, for detecting fluorescence of the target fluorophore partitioned into the partitioning element 240. The test system 100 may also include optics for irradiating and detecting the calibration fluorophore, mentioned above, to provide a baseline optical signal for calibration and/or monitoring of the optical signal path integrity. In such embodiment, fluorescence produced by the target and calibration fluorophores must be differentiated and detected. Thus, for example, the optical path 480 for detecting fluorescence emitted from the partitioning element 240 may include a beam splitter and mirror that splits the optical path 480 into two channels. Each channel may be filtered using an optical filter at the wavelength of the fluorophore of interest (i.e., the target and calibration fluorophores) and the filtered optical signals may be subsequently detected.

According to one embodiment, the test system 100 includes a data processing system 300 to allow users to control its operation. The data processing system 300 may include acquisition/processing/display devices and an interface (e.g., to the Internet, etc.) to allow the system 100 to be networked to an external supervisory control and data acquisition (“SCADA”) system.

Thus, according to one embodiment, there is provided a system 100 for detecting presence of an organism having an enzyme in a sample, comprising: a cartridge 200 for containing the sample and a substrate 210 such that the enzyme can react with the substrate to produce a biological molecule; a partitioning element 240 mounted in a recess 250 in a base 220 of the cartridge 200, the partitioning element 240 allowing partitioning of the biological molecule thereinto; a light source 420 for irradiating the biological molecule partitioned into the partitioning element 240; and, a detector 470 for detecting fluorescence of the biological molecule partitioned into the partitioning element 240, the detected fluorescence being indicative of presence of the organism in the sample; wherein the light source 420 is in a raised cartridge mount 150 of the system 100 that mates with the recess 250 in the base 220 of the cartridge 200. The recess 250 in the base 220 of the cartridge 200 prevents contact of the optical coupling interface (e.g., light source 420, etc.) with surfaces or other sources of debris or contamination during handling of the sample.

The system 100 may further include a test chamber 130 for receiving the cartridge. The test chamber 130 may be an incubator having a heating system associated therewith. The raised cartridge mount 150 may be positioned at an angle within the system 100 to minimize residue build-up on optical components (e.g., 430, 440, 450) and avoid contact of the sample with a lid 230 of the cartridge 200. The angle may be about 25 degrees. The raised cartridge mount 150 may include a sensor 160 for detecting whether the cartridge 200 is present. The light source 420 may be a light emitting diode (“LED”). The LED 420 may be mounted at an angle to reduce direct reflection of light from the light source 420 off of the base 220 of the cartridge 200 toward optical components (e.g., 430, 440, 450) of the system 100 and to optimize detection of fluorescence of the biological molecule partitioned into the partitioning element 240. The angle may be about 65 degrees. And, the recess 250 may have a depth that is selected to reduce contact of the partitioning element 240 with contaminants. Note that the sample may be in a liquid phase and/or a solid phase.

While aspects of this invention may be discussed as a method, a person of ordinary skill in the art will understand that the apparatus discussed above with reference to a data processing system 300 may be programmed to enable the practice of the method of the invention. Moreover, an article of manufacture for use with a data processing system 300, such as a pre-recorded storage device or other similar computer readable medium including program instructions recorded thereon, may direct the data processing system 300 to facilitate the practice of the method of the invention. It is understood that such apparatus and articles of manufacture also come within the scope of the invention.

In particular, the sequences of instructions which when executed cause the method described herein to be performed by the data processing system 300 can be contained in a data carrier product according to one embodiment of the invention. This data carrier product can be loaded into and run by the data processing system 300. In addition, the sequences of instructions which when executed cause the method described herein to be performed by the data processing system 300 can be contained in a computer software product according to one embodiment of the invention. This computer software product can be loaded into and run by the data processing system 300. Moreover, the sequences of instructions which when executed cause the method described herein to be performed by the data processing system 300 can be contained in an integrated circuit product (e.g., a hardware module or modules 321) which may include a coprocessor or memory according to one embodiment of the invention. This integrated circuit product can be installed in the data processing system 300.

### Calibration and Quality Control

In one embodiment of the present detection system and that of U.S. Pat. No. 7,402,426, a sample which is positive for total coliform (TC) is detected when hydroxyanthracene produced by the bacteria from the substrate partitions into the polymer partitioning element. The hydroxyanthracene in the polymer is excited by the UV LED in the optical system and fluorescence emission results. A sample which is positive for E. coli (EC) is detected when hydroxypyrene produced by the bacteria from the substrate partitions into the polymer partitioning element and is similarly detected. A negative sample will have no hydroxyanthracene or hydroxypyrene in the partitioning element and a “background” fluorescence signal will be detected.

The hydroxyanthracene and hydroxypyrene molecules are stable for several hours, but are not stable for many days, so quality control cartridges which are stable on storage for weeks or months cannot be made by keeping cartridges from positive tests, or by making cartridges with hydroxyanthracene or hydroxypyrene added to the polymer.

Furthermore, using such quality control cartridges is time consuming as an enzyme-substrate reaction is required prior to use. Furthermore, they are not readily portable or reusable as the cartridges contain liquid. Also, as the calibration is subject to a reaction itself and opening and closing of vials, such quality control cartridges are susceptible to contamination and thus may result in false positive or negative readings of test samples.

The present inventors have developed quality control materials and quality control cartridges that overcome many of the above-noted deficiencies.

The present inventors have developed positive controls that mimic results at particular selected spectra from positive E. coli and/or TC samples and also negative samples.

The quality controls comprise a polymer, with a fluorophore already present within it. In one embodiment, the polymer is the same polymer used in the partitioning element of the test cartridges.

Quality control samples or cartridges for testing the pathogen detection instrument/system such as described herein or the like, such as in U.S. Pat. No. 7,402,426, may mimic the signal produced from a “positive” sample during detection of bacteria. For example, two types of quality control cartridges may be prepared to mimic the signal from a sample positive only for coliform bacteria (Total Coliform or TC test) as well as for samples which are contaminated with E. coli bacteria (EC test). As EC bacteria are normally also detected as coliform bacteria, samples containing EC bacteria are classified as “EC and TC positive”. An embodiment of a QC cartridge which mimics samples negative for EC and TC has also been made.

A sample which is positive for TC is detected when hydroxyanthracene produced by the bacteria from the substrate partitions into the polymer partitioning element. The hydroxyanthracene in the polymer is excited by the UV LED in the optical system of the instrument and fluorescence emission results. A sample which is positive for EC is detected when hydroxypyrene produced by the bacteria from the substrate partitions into the polymer partitioning element and is similarly detected. A negative sample will have no hydroxyanthracene or hydroxypyrene in the polymer and a “background” fluorescence signal will be detected.

### Positive Sample Mimics

Quality control samples or cartridges using other fluorescent molecules (fluorophores) added to the polymer that produce fluorescence signals which mimic those of the positive samples are provided herein. These other fluorophores are stable in the polymer for many months and the quality control cartridges may be used regularly over an extended period (e.g., weeks, months, or years) to test an instrument.

To select fluorophores for the quality control samples or cartridges, the fluorescence signal monitored in the pathogen detection test was considered. The fluorescence from hydroxypyrene is monitored at 385 nm and from hydroxyanthracene is monitored at 485 nm. While both molecules have spectra that feature emission over a range of wavelengths, 385 nm was chosen as the wavelength where hydroxypyrene is detected with the least interference from emission of hydroxyanthracene, and 485 nm was chosen as the wavelength where hydroxyanthracene is detected with the least interference from emission of hydroxypyrene.

The quality control sample or cartridge fluorophores were chosen such that one would produce a signal at 385 nm but not at 485 nm, and the other would produce a signal at 485 nm but not at 385 nm. Other than achieving this requirement, it was not necessary for the fluorophores in the quality control cartridge to exactly reproduce the entire spectrum of hydroxypyrene and hydroxyanthracene.

An example of a fluorophore that may be used to produce the 385 nm signal is Exalite 398. An example of a fluorophore that may be used to produce the 485 nm signal is Coumarin 540a. The structures of these compounds are shown below:

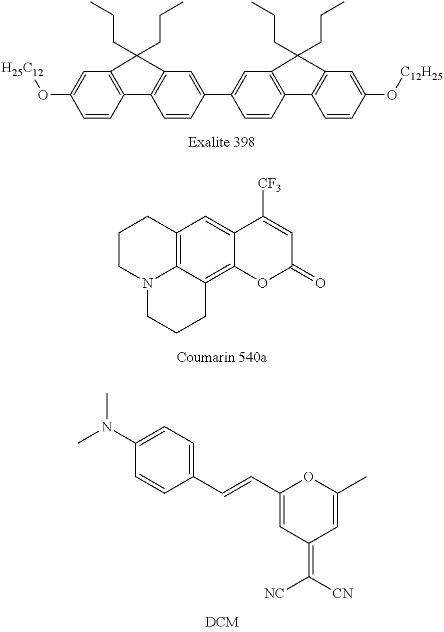

### Negative Sample Mimic

The quality control sample or cartridge that mimics a negative sample (QC—Neg) should produce a low signal at 385 nm and 485 nm corresponding to the signal from a control test cartridge (e.g., a cartridge filled with water but containing no EC or TC bacteria). One candidate for this is to place a sterile water sample in a test cartridge, however a sample containing water is not convenient for handling or long-term storage. It is not possible to produce the negative control cartridge by simply making a cartridge with a polymer partitioning element containing no additional molecules. Such a cartridge produces significant background signal because of greater reflection of excitation light towards the detection optics than occurs in a test cartridge filled with water. However, a negative quality control cartridge may be prepared by adding a molecule to the polymer partitioning element that absorbs some of the excitation light and reduces the reflection signal to achieve the required background signal at 385 nm and 485 nm. For example, in one embodiment the molecule is 4-dicyanomethylene-2-methyl-6-(p(dimethylamino)styryl)-4H-pyran (DCM—structure shown above), which is in fact a fluorophore, but its fluorescence emission is at a longer wavelength region and does not interfere with achieving a low background signal at the required wavelengths to mimic a negative sample.

In one aspect the quality control samples or cartridges of the present invention can be used to calibrate a test chamber of a system wherein one or more positive and/or negative controls can be placed in the test chamber prior to placing a test cartridge in the chamber, to calibrate the test chamber. In one embodiment, as the fluorescence of the quality control samples or cartridges at particular wavelengths are known, this can be used to calibrate the test chamber and/or determine as to whether the test chamber is functioning properly or if any of the components of said system or test chamber (such as any leads thereto) require replacing. In so far as the system or test chamber cannot be calibrated or the signal is off, then this can be indicative of the requirement of servicing of the system or replacing various components thereof or the test chamber.

In one embodiment, quality control samples or cartridges of the invention can be used prior to inserting a cartridge containing a sample to be tested, to calibrate the test chamber and/or the system, or they can be used between insertion of cartridges containing test samples to recalibrate or check or monitor the functioning or performance of the test chamber and/or the system.

In another embodiment, wherein the detection system comprises multiple test chambers, one or more of the test chambers may be used to calibrate the system and those test chambers in which the quality control sample or cartridge is placed, and may also be used to calibrate other test chambers in the system. In one embodiment the system can be programmed when reading the fluorescence of a test sample to compare it to the reading of a test chamber in which the quality control sample or cartridge is placed. In one embodiment, such comparison readings are done at the same wavelength. Thus, in one embodiment, the system can be calibrated not only before or after the reading of a test cartridge placed in the same or different test chamber, but also continuously or at periodic times before, during or after monitoring of the readings in a test sample.

In another embodiment, a person of skill in the art would appreciate that calibration of a test chamber or chambers or the system can be done by comparing the readings of a quality control sample or cartridge of the present invention to known readings and thus calibrating the test chamber(s) or system accordingly.

As in one embodiment, the quality control materials/cartridges are made with a pre-known fluorescence intensity at a particular wavelength (e.g., a fluorophore and optionally a molecule that at least absorbs light to reduce residual background signal (e.g. absorbs at least some or all of the light of the spectra and residual background signal), for example DCM, incorporated into a polymer (e.g. can be the same material as the partitioning element of a test cartridge)], if the detector and/or system indicates a fluorescence intensity higher or lower than the known amount or level of the control, the system can be calibrated accordingly so that the output (fluorescence detected) matches the known levels for the controls. Fluorescence from the cartridges containing samples to be tested can then be processed accordingly using the calibrated detection system.

The calibration method can also include comparing readings of an empty test chamber with that when a quality control sample or cartridge is used. The empty chamber provides background signals of the test chamber(s) or system. In another aspect background signals can be monitored using a negative quality control sample or cartridge. One or more of the above aspects can be incorporated into the calibration methods of the present invention.

### Examples

### Preparation of Quality Control Cartridges

The quality control cartridges were made by creating polymer partitioning elements of polydimethyl siloxane using Sylgard 184 material from Dow Inc.

A quality control cartridge mimicking a sample with TC only (QC—TC) contained 0.1 mg Coumarin 540a/g polymer and had 0.05 mg DCM/g polymer added to reduce background signal.

A quality control cartridge mimicking a sample with EC and TC bacteria (QC—EC+TC) contained 0.075 mg Coumarin 540a/g polymer and 0.075 mg Exalite 398/g polymer.

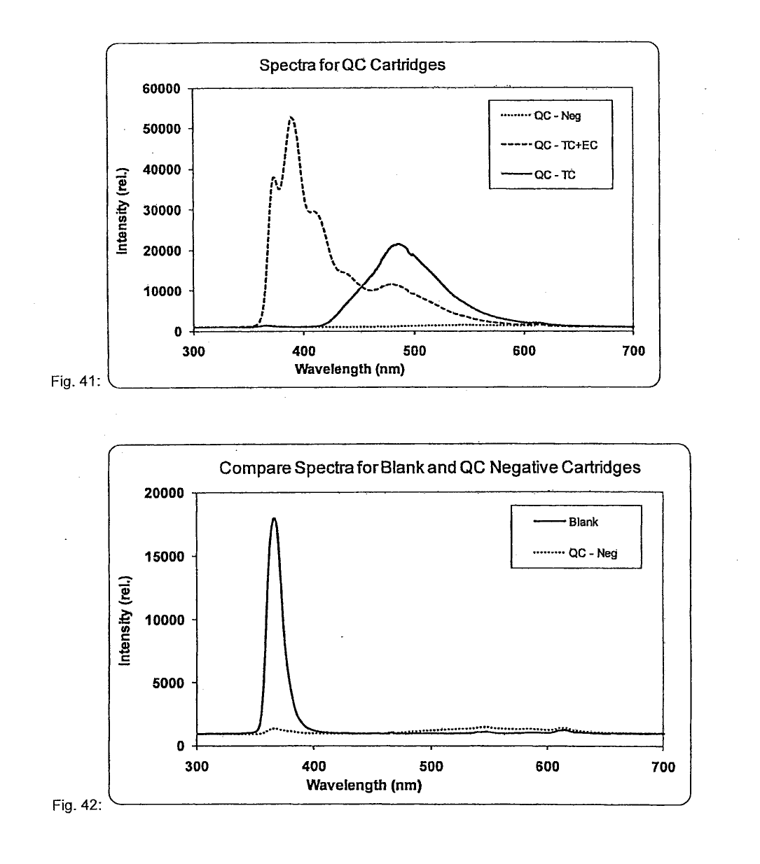

A quality control cartridge mimicking a negative sample (QC—Neg) contained 0.05 mg DCM/g polymer. The spectra of the QC—Neg, QC—TC and QC—EC+TC cartridges are shown in FIG. 41.

The spectra of a blank sample cartridge (contains water but no EC or TC) and the QC—Neg cartridge containing DCM are shown in FIG. 42. The blank cartridge shows low background signal at 385 nm and 485 nm but a significant peak at 365 nm which is scatter of the excitation light from the LED. The QC—Neg cartridge does not have the 365 nm peak, illustrating that the DCM is absorbing the excitation light. The QC—Neg cartridge does show a small signal above the blank sample signal from 500 nm to 600 nm, corresponding to fluorescence from the DCM, but signal at 385 nm and 485 nm is lower than the blank sample, as required.

The embodiments of the invention described above are intended to be exemplary only. Those skilled in this art will understand that various modifications of detail may be made to these embodiments, all of which come within the scope of the invention.

1. Control material for a system detects a presence of an organism in a sample, the sample being contained in a test cartridge;
wherein the system detects fluorescence of:
(a) a biological molecule partitioned into a partitioning element of the test cartridge, wherein the biological molecule is produced by a reaction of an enzyme of the organism and a substrate; or
(b) the control material;
wherein the control material comprises:
(i) a polymer and a fluorophore that is a positive mimic of all or part of a fluorescence spectrum of the biological molecule; or
(ii) a polymer and a fluorophore that is a negative mimic of all or part of a fluorescence spectrum of the biological molecule; or
(iii) a polymer, a fluorophore that is a positive mimic of all or part of a fluorescence spectrum of the biological molecule, and a fluorophore that is a negative mimic of all or part of the fluorescence spectrum of the biological molecule.

2. The control material of claim 1, wherein the control material is contained in at least one control cartridge substantially identical in size and shape to the test cartridge.

3. The control material of claim 2, wherein the system comprises a test chamber for receiving independently the test cartridge or a control cartridge.

4-11. (canceled)

12. A method for calibrating a system for detecting a presence of an organism in a sample, wherein the system detects fluorescence of a biological molecule partitioned into a partitioning element, wherein the biological molecule is produced by a reaction of an enzyme of the organism and a substrate, the method comprising:
using a control material comprising
(i) a polymer and a fluorophore that is a positive mimic of all or part of a fluorescence spectrum of the biological molecule to establish a condition wherein fluorescence of the biological molecule is detected in the partitioning element; or
(ii) a polymer and a fluorophore that is a negative mimic of all or part of a fluorescence spectrum of the biological molecule to establish a condition wherein fluorescence of the biological molecule is not detected in the partitioning element; or
(iii) a polymer, a fluorophore that is a positive mimic of all or part of a fluorescence spectrum of the biological molecule to establish a condition wherein fluorescence of the biological molecule is detected in the partitioning element, and a fluorophore that is a negative mimic of all or part of a fluorescence spectrum of the biological molecule to establish a condition wherein fluorescence of the biological molecule is not detected in the partitioning element;
wherein such calibration prepares the system for testing a sample, confirms proper performance of the system, or confirms a result obtained for a sample.

13. (canceled)

14. The method of claim 12, wherein the partitioning element is disposed in a test cartridge, and the control material comprises at least one control cartridge substantially identical in size and shape to the test cartridge.

15. (canceled)

16. The control material of claim 1, wherein the polymer comprises polydimethylsiloxane.

17-24. (canceled)

25. The method of claim 14, wherein the system comprises a test chamber adapted to receive the test cartridge or a control cartridge; the method further comprising disposing at least one control cartridge in the test chamber to calibrate the system.

26. The control material of claim 1, wherein fluorescence of the fluorophore that is a positive mimic of all or part of a fluorescence spectrum of the biological molecule and of the fluorophore that is a negative mimic of all or part of a fluorescence spectrum of the biological molecule at a selected wavelength is known, to enable calibration of the system.

27. The control material of claim 26, wherein the organism is E. coli, total coliform, or E. coli and total coliform.

28. The control material of claim 27, wherein the fluorophore that is a positive mimic is selected to produce a signal at 385 nm.

29. The control material of claim 28, wherein the fluorophore is Exalite 398.

30. The control material of claim 27, wherein the organism is total coliform and the fluorophore that is a positive mimic is selected to produce a signal at 485 nm.

31. The control material of claim 30, wherein the fluorophore is Coumarin 540a.

32. The control material claim 1, wherein the control material further comprises a molecule in the polymer that absorbs light to reduce a reflection signal to achieve a selected background signal.

33. The control material of claim 32, wherein the molecule absorbs light to achieve a background signal at 385 nm, 485 nm, or 385 nm and 485 nm.

34. The control material of claim 32, wherein the molecule absorbs light to achieve a background signal at 385 nm.

35. The control material of claim 32, wherein the molecule absorbs light to achieve a background signal at 485 nm.

36. The control material of claim 32, wherein the molecule is 4-dicyanomethylene-2-methyl-6-(p(dimethylamino)styryl)-4H-pyran (DCM).

37. The control material claim 1, wherein the sample is a liquid or liquefied sample.

38. The control material of claim 37, wherein the sample is a water sample.
